(19) United States
(12) Patent Application Publication
(10) Pub. No.: US 2023/0222404 A1
(43) Pub. Date: Jul. 13, 2023

(54) HOME INTELLIGENCE GAMING SYSTEM

(71) Applicant: Curb, Inc., Austin, TX (US)

(72) Inventors: Erik Norwood, Austin, TX (US); Eric Gould Bear, Austin, TX (US)

(21) Appl. No.: 18/171,625

(22) Filed: Feb. 20, 2023

Related U.S. Application Data
(63) Continuation-in-part of application No. 16/953,931, filed on Nov. 20, 2020, now Pat. No. 11,586,998.
Application No. 16/953,931 is a continuation of application No. 16/427,915, filed on May 31, 2019, now Pat. No. 10,846,628.
Application No. 16/427,915 is a continuation of application No. 14/469,651, filed on Aug. 27, 2014, now Pat. No. 10,318,895.
Application No. 14/469,651 is a continuation of application No. 16/253,164, filed on Jan. 21, 2019, now abandoned.
Application No. 16/253,164 is a continuation of application No. 14/944,118, filed on Nov. 17, 2015, now Pat. No. 10,187,707.
(60) Provisional application No. 61/870,750, filed on Aug. 27, 2013.
(60) Provisional application No. 62/080,949, filed on Nov. 17, 2014.

(51) Int. Cl. G05B 15/02

(52) U.S. Cl. CPC G05B 15/02

(57) ABSTRACT

Gaming systems, apparatus and methods for providing information about electrical devices associated with an entity are described, which may be implemented to promote more efficient use of resources by players by monitoring their use of said resources in a competitive gaming system. Various components may determine electrical signatures specific to electrical devices that are receiving electrical power through power lines, identify electrical devices, and make predictions on power consumption. A notification component determines events or conditions associated with specific electrical devices (e.g. abnormal usage, device failure, excess power consumption), and notifications relating to such events or conditions is provided to a person. Some implementations include determining and promoting goals for resource consumption and tracking/monitoring the progression of one or more players in reaching said goals. The system may include tracking different players' progress and providing updates of said progress in a points system where the players are competing.

### PRIORITY CLAIM

This application is a continuation of U.S. patent application Ser. No. 16/253,164 entitled “HOME INTELLIGENCE SYSTEM” filed Jan. 21, 2019, which is a continuation of U.S. patent application Ser. No. 14/944,118 entitled “HOME INTELLIGENCE SYSTEM” filed Nov. 17, 2015 (now U.S. Pat. No. 10,187,707), which claims priority to U.S. Provisional Application Ser. No. 62/080,949 entitled “WHOLE HOME INTELLIGENCE SYSTEM WITH DISAGGREGATION OF ELECTRICAL DEVICES AND DEVICE-SPECIFIC NOTIFICATIONS” filed Nov. 17, 2014. This application is also a continuation-in-part of U.S. patent application Ser. No. 16/953,931 entitled “GAMING APPARATUS BASED ON COMPETITIVE USE OF RESIDENTIAL ENERGY” filed Nov. 20, 2020 (now U.S. Pat. No. 11,586,998), which is a continuation of U.S. patent application Ser. No. 16/427,915 entitled “SYSTEM FOR PROMOTING EFFICIENT USE OF RESOURCES” filed May 31, 2019 (now U.S. Pat. No. 10,846,628), which is a continuation of U.S. patent application Ser. No. 14/469,651 entitled “SYSTEM FOR PROMOTING EFFICIENT USE OF RESOURCES” filed Aug. 27, 2014 (now U.S. Pat. No. 10,318,895), which claims priority to U.S. Provisional Application Ser. No. 61/870,750 entitled “SYSTEM FOR PROMOTING EFFICIENT USE OF RESOURCES” filed Aug. 27, 2013. All of which are incorporated herein by reference in their entirety.

### BACKGROUND

### Field

The present invention relates to a gaming apparatus for the management and use of resources, such as energy. More particularly, the present invention relates to systems and methods for promoting reduced consumption of energy involving acquiring and transmitting information about resource usage in residences and other buildings.

### Description of the Related Art

A typical modern home has numerous electrical devices that serve a variety of purposes. In addition to basic systems such as lighting, air conditioning, and standard kitchen appliances, the modern home a myriad of other electrical devices for leisure activities, communication, personal business, entertainment, exercise, and home security. Each of these electrical devices in the home consumes energy. Also, each of these electrical devices is a potential point of failure and may need to be replaced or repaired, often at an inconvenient time.

As energy costs increase, many energy customers feel powerless and upset about high electricity bills. Homeowners and other energy customers have expressed interest in devices that can help monitor home energy use. Today's tools for monitoring energy may not, however, provide a way for a homeowner to know which devices in a home use the most power and which waste the most energy. Smart home systems have gained significant traction, but none provide a solution that encompasses the entire home. A smart device, for example, is typically a point solution that only controls a single outlet or provides a single function.

Every year, occupants of commercial properties and public sector buildings consume far more electricity than is actually required. Billions of dollars are wasted. Some efforts have been made to curtail this waste through energy management systems, automated temperature and lighting controls, and even basic infrastructure replacement with efficiency upgrades. Nevertheless, these efforts have been only partly successful in eliminating waste.

Enterprise office and industrial buildings, public sector facilities, and other commercial properties have a higher plug load today than several decades ago. Individuals are consuming a higher percentage of a building's energy than years past. Some of the energy waste in commercial properties could be reduced by actions and choices of the occupants in the building (for example, an office worker turning off the lights as the office worker leaves the office at the end of the work day). In any given environment, however, individuals may have neither sufficient information nor sufficient motivation to reduce consumption in a significant way.

### SUMMARY

Systems and methods for acquiring and using information about electrical device usage are described. In an embodiment, a system for providing information about electrical devices in a residence includes a power measurement device, an electrical device identification component, and a notification component. The power measurement device measures characteristics of electrical power in one or more electrical power lines in the residence. Based on the measured electrical characteristics, the electrical device identification component determines electrical signatures specific electrical devices at the residence that are receiving electrical power through the electrical power lines, associates the electrical devices with a device type, and groups the electrical devices into zones of the residence. Based on power consumption by the specific electrical devices, the notification component determines events or conditions associated with specific electrical devices (for example abnormal usage, device failure, excess power consumption). Notifications relating to at least one of the events or conditions associated with the specific electrical devices are provided to a person associated with the residence (for example, homeowner or other resident).

In an embodiment, a method of providing information about electrical devices in a residence includes measuring characteristics of electrical power lines in the residence. Based on the measured electrical characteristics, electrical signatures for each of at least two of a plurality of electrical devices at the residence that are receiving electrical power from the electrical power lines. Based on the electrical signatures, electrical devices with a device type. The devices are grouped into zones of the residence. Based on power consumption by specific electrical devices, events or conditions associated with the specific electrical device are determined. Notifications relating to the events or conditions associated with the specific electrical devices are provided to a person associated with the residence.

In an embodiment, a method of providing information about electrical devices in a residence includes measuring characteristics of electrical power lines in the residence. Based on the measured electrical characteristics, electrical signatures electrical devices at the residence are determined. A state or usage level of specific electrical devices are detected wherein the power consumption by the specific electrical device is detected using the electrical signatures for the electrical devices. Based on the state or usage level detected for the specific electrical devices, events or conditions associated with the specific electrical devices are determined. Notifications relating to the events or conditions associated with the specific electrical devices are provided to a person associated with the residence.

In an embodiment, a method of managing electrical devices in a residence includes determining electrical signatures for specific electrical devices at the residence based on measured electrical characteristics. Use of the electrical devices is detected using the electrical signatures for the specific electrical devices. Device-specific notifications are provided to a person associated with the residence. In response to device-specific notifications, electrical devices in the residence are controlled.

In an embodiment, a method of providing information about electrical devices in a residence includes determining electrical signatures for specific electrical devices at the residence based on measured electrical characteristics. Use of the electrical devices is detected using the electrical signatures for the specific electrical devices. Device-specific notifications are provided to a person associated with the residence. Based on the use of the specific electrical device, a suggestion for acquiring one or more products or one or more services is determined. The suggestion is provided to a person associated with the residence.

In an embodiment, a method of managing levels of power consumption of electrical devices used by an organization in its facilities includes measuring one or more characteristics of electrical power lines in a set of one or more buildings in which the organization operates. Based on the measured electrical characteristics, electrical signatures are determined for specific devices of electrical devices at the one or more buildings. Power consumption by specific electrical devices is detected using the electrical signatures. Based on the power consumption detected by the electrical devices, an operating specification for the electrical devices at the buildings is determined. The operating specifications manage power consumption for electrical loads at the set of one or more buildings. The operating specifications may reduce a peak load for the buildings.

In an embodiment, a system includes a plurality of conductors that couple with sensors. The sensors measure characteristics of power in electrical power lines. An analog-to-digital converter receives signals from the electrical power lines and converts the signals from analog signals to digital signals. A processor receives digital signals from the analog-to-digital converter, one or more digital signals perform digital signal processing on at least one of the signals and performs digital signal processing. Based on the digital signal processing, an electrical signature for the electrical devices receiving power from at least one of the electrical power lines is determined.

In an embodiment, an electrical signature capture pre-processing device includes a plurality of conductors, an analog-to-digital converter, and an electrical signature pre-processing component. The conductors couple with electrical sensors that measure characteristics of power in electrical power lines in a building. The electrical signature pre-processing component receives, from the analog-to-digital converter, one or more digital signals. The electrical signature pre-processing component performs digital signal processing on the signals to determine a set of information for computing an electrical signature for at least one specific electrical device in the building. The electrical signature pre-processing component sends information to an electrical signature computation component. The information sent to the electrical signature computation component includes information for determining electrical signatures for specific electrical device in the building. A microcontroller controls one or more of the electrical devices in the building.

Systems and methods for promoting efficient use of resources are described. In an embodiment, a method of promoting more efficient use of a resource includes acquiring values associated with consumption of a resource by an entity (for example, a group of people occupying an office building) at a place (for example, a floor the building). A normalization of the values may be performed. While the resource is being consumed at the place, comparisons based on the normalized values associated with consumption of the resource at the place and one or more other values associated with consumption of the resource are displayed to one or more persons of the entity. In some cases, the entity is an individual person and the comparisons are displayed to that person.

In some cases, consumption of the entity is compared with consumption by one or more other entities (for example, in a graph comparing one office building's power consumption for the week with power consumption of another office building.) The consumption information may be used to conduct games or contests between entities to promote more efficient consumption of the resources. For example, occupants of different buildings can compete with one another to reduce consumption of electricity.

In an embodiment, a method of promoting more efficient use of a resource includes acquiring values associated with consumption of a resource by an entity. Based on the values acquired, one or more goals for more efficient consumption of the resource by the entity are determined. The goals are displayed to a person in the entity. One or more indicators of progress by the entity toward the goals may be displayed.

In an embodiment, a method of promoting more efficient use of a resource includes acquiring values associated with consumption of a resource by an entity. While the resource is being consumed by the entity, a radial graph reflecting resource consumption is displayed. The radial graph includes consumption level indicators that appear sequentially around a circle. The consumption level indicator bars may indicate a level of consumption of the resource at successive periods in time.

In an embodiment, a method of promoting more efficient use of a resource includes acquiring values associated with consumption of a resource by an entity. While the resource is being consumed by the entity, a dynamic indicator is displayed indicating resource consumption. The dynamic indicator may include characteristics that are analogous to a human physiological indicator, such as a heartbeat. The rate of consumption of the resource may correspond to the human physiological indicator.

In an embodiment, a method of promoting more efficient use of a resource includes receiving, from each of two or more entities consuming a resource (for example, two or more persons in an office building), an input signal to control or influence use of the resource. Based on the input signal for at least one of the entities, one or more offsetting measure options are identified. The offsetting measure options are actions that the entity could take that would offset at least a portion of the consumption of the resource by the entity. The offsetting measure options are displayed to the entity. For example, when an individual wants to consume more energy by heating the building, the system may present the individual with ways to offset this consumption, such as turning off the overhead lights for a specific amount of time.

In an embodiment, a method of reducing ecological impact by an entity at a place includes acquiring values associated with ecological impact of actions by an entity at the place. A normalization of the values is performed. Comparisons based on the normalized values associated with the actions by the entity and one or more other values associated with ecological impact are displayed.

In an embodiment, a method of promoting improved environmental quality in a building includes acquiring values associated with environmental quality in a building A normalization of the values is performed. Comparisons based on the normalized values are displayed to occupants of the building. Ranges for acceptable environmental quality are shown and compared to the actual environmental values. For example, an acceptable range for carbon dioxide (“CO2”) is shown and the actual CO2 levels are plotted to highlight if the current values are within the acceptable range.

### BRIEF DESCRIPTION OF THE DRAWINGS

FIG. 1 illustrates one embodiment of a system for promoting lower resource consumption.

FIG. 2 illustrates one embodiment of a system that monitors and reports resource consumption information from multiple buildings.

FIG. 3 illustrates one embodiment of a display having a radial graph of power consumption for a user.

FIG. 4 is a detail view of a radial graph that can be used to report resource consumption.

FIG. 5 illustrates a banner for a user display for real-time power consumption by a user. The banner may show specific energy consumption tips and details about which loads are on or off based on the software algorithms.

FIG. 6A illustrates one embodiment of a usage box for a display.

FIG. 6B illustrates a competition results box for a competition among users.

FIG. 6C illustrates a line graph showing results of a competition.

FIG. 6D illustrates a weekly report showing the status of a competition among teams.

FIG. 7 illustrates one embodiment of a report showing a user's consumption and savings that can be displayed on a user device.

FIG. 8 illustrates one embodiment of a second report of a user's consumption and savings that can be displayed on a user device.

FIG. 9 illustrates a display of a historical view for resource consumption by a user.

FIG. 10 illustrates one embodiment of a set of widgets for a power consumption display.

FIGS. 11A through 11C illustrate a radial graph display at different times.

FIGS. 12A and 12B illustrate a display including a heartbeat visual indicator in a radial graph of power consumption.

FIG. 13 illustrates an embodiment of a home intelligence system including a local signature capture device.

FIG. 14 illustrates disaggregation and device-specific notification according to one embodiment.

FIG. 15A illustrates one embodiment of a signal produced by measuring electrical power lines supplying power to an air conditioner. 15B illustrates a transformation of the signal for the air conditioner into a frequency domain.

FIG. 16A illustrates one embodiment of a signal produced by measuring electrical power lines supplying power to a 32 inch LCD television. FIG. 16B illustrates a transformation of the signal for the 32 inch LCD television into a frequency domain.

FIG. 17 is a graph illustrating on/off tracking of several electrical devices in a residence.

FIG. 18 illustrates one embodiment of a display for providing information about usage of electrical devices in a residence to a home owner, by device and zone.

FIG. 19 illustrates one embodiment of a display for providing information about usage of electrical devices in a residence to a home owner, with a breakdown by zone, room, or display.

FIG. 20 illustrates one embodiment of a display for providing information about usage of electrical devices in a residence to a home owner, with forecasted usage by room, appliance, and zone.

FIG. 21 illustrates one embodiment of a display for providing information about usage of electrical devices in a residence to a home owner, with three-hour peak consumption identification by zone and appliance.

FIG. 22 illustrates one embodiment of a display of a tutorial for a homeowner about usage of electrical devices in a residence. The tutorial guides the homeowner to use the display options to evaluate the effects of using various devices on total energy consumption.

FIG. 23 illustrates one embodiment of a display with a graph showing a comparison of different usage to their typical energy consumption and to each other.

FIG. 24 illustrates one embodiment of a signature capture device installed at the breaker box of a residence.

FIG. 25 illustrates one embodiment of input/output for a signature capture system.

FIG. 26 illustrates one embodiment of an embedded controller board for a signature capture device.

FIG. 27 illustrates one embodiment of a cloud computing system that can be implemented to carry out building intelligence, device disaggregation, notifications, recommendations, and control.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS

As used herein, displaying or presenting a “comparison” includes displaying or presenting information that shows differences between one value and another value. A comparison may be graphical, tabular, or other format. For example, a comparison of power consumption rates by two competitors may be displayed by tabulating usage of the two competitors for a given time period, or by displaying a graph having a different plot for each of the competitors.

As used herein, “entity” includes a person or a group of persons. Some examples of entities include a group of occupants of a building or segment of a building, the employees of a company, a team, a department, a city, a company, a department, or a class of students. In some instances, a group of residences may be considered an entity. For example, a group of residences and/or buildings in a geographically-defined area such as a neighborhood, a neighborhood association, a business complex, or any group of residences or buildings connected to a grid substation may be considered an entity. In some instances, an entity may be associated with a region such as a neighborhood, city, or other geographically-defined area.

As used herein, to “handicap” means to adjust a value to compensate for one or differences in two or more things being compared.

As used herein, to “normalize” means to adjust one or more values to put the values on a common scale for comparison with another value, or to facilitate a fair comparison between two entities being compared.

As used herein, a “place” means a portion of a space, building, or location that can be occupied by one or more persons. Examples of a place includes an entire building, a floor of a building, a wing of a building, a factory room, a warehouse, a retail store, a place of business, a medical facility, a warehouse, an office, or the energy provided by a single outlet.

As used herein, a “resource” means a source from which a material, energy, or asset can be supplied for the use or benefit of a person or group of persons. Examples of resources include energy, electrical power, water, gas, fuel, and specific qualities of air and light within the building.

As used herein, as it pertains to devices, a “signature” includes any set of information derived from a signals associated with a device that can be used to distinguish the device from other devices. In some embodiments, a signature includes a set of frequencies and corresponding amplitudes of voltage or current. In some embodiments, a signature for a device is derived from measurements taken on electrical power lines that supply power to the device. In some embodiments, a signature is derived from non-intrusive load monitoring.

As used herein, a “suggestion” includes a suggestion, idea, proposal, proposition, recommendation, invitation, or tip. A suggestion may include, for example, a recommendation to acquire a specific product or service, or take a particular action.

As used herein, a “user” means a person or groups of persons that can user or consume one or more resources.

As used herein in the context of observing a process or condition, “real-time” means without delay perceivable by the observer. A real-time display of power consumption may include an actual delay. For example, if a user turns off an appliance, an actual delay may occur before the user's power consumption display reflects the reading due to the time for the computer system to receive load sensor information, recalculate a value, and generate an updated display, and the network to transmit the updated information.

Systems for Providing Information to a User about Electrical Power Consumption

In some embodiments, a system displays current information about a user's consumption of a resource to the user. The user may be an individual person or a group of persons. The display may include real-time updates of the information. Energy consumption information may be refreshed on a frequent basis (for example, up-to-the-second). Resource consumption information may be displayed on any of various displays, including centralized screens, web pages of individual workstations, or mobile devices.

Consumption information may be presented at a compartmentalized level, in real-time. The display may be for a residence, office building, or a portion thereof (such as a wing or floor, a single office, or a department spread across different sections of a building). Users may receive immediate notice of an increase or decrease power use. Additionally, user may receive notices whether or not the user is looking at a display. Important notices that correspond to energy consumption events or significant billing triggers may be “pushed” to users mobile devices to alert them to change consumption patterns.

In some embodiments, resource consumption information of one or more other users is displayed with resource consumption information of one or more other users or places. For example, consumption information may be presented showing user against user, department against department, and building against building. The data may be normalized to promote fairness (accounting, for example, for capacity, weather differences, varying facility ages) and then displayed so that each person or group can gauge its performance against another user. The comparison may be shown on any suitable time interval. Examples of time intervals for comparison include per second, per hour, per day, per business day, per holiday, per month, per season, and per year.

In displaying resource consumption information, a system may account for multiple variations between the places different users are located. Examples of variations that may be accounted for include building capacity, building age, weather differences, age of systems (for example, air conditioning system), number of occupants, and type of use (factory production, office, medical facility).

In some embodiments, a system includes energy use monitoring devices, such as power meters. The energy monitoring devices feeding information to a power consumption monitoring system may read consumption data down to the circuit level or the plug-level. The system may allow set-ups by a user (for example, a system administrator) and goals to be defined and redefined as needed.

Resource consumption information may be acquired for many different types of places and different users. A user may be an individual or a group of individuals (for example, all the occupants on the floor of an office building). In some embodiments, resource consumption information is made accessible individually to each person. For example, each employee of a company may have access to a display showing consumption information for that employee, or showing consumption for a group of persons associated with that employee (for example, all the employees that share a floor of an office building with the employee.) Consumption information may be disseminated using any of various devices, such as a cell phone, tablet, desktop computer, local displays, or kiosks. By presenting information to individual users, the individual consumers receive information for bottom-up decision making. For example, if the system display shows an employee that energy is being wasted by overuse of a particular appliance, that employee can take corrective action to reduce use of that appliance.

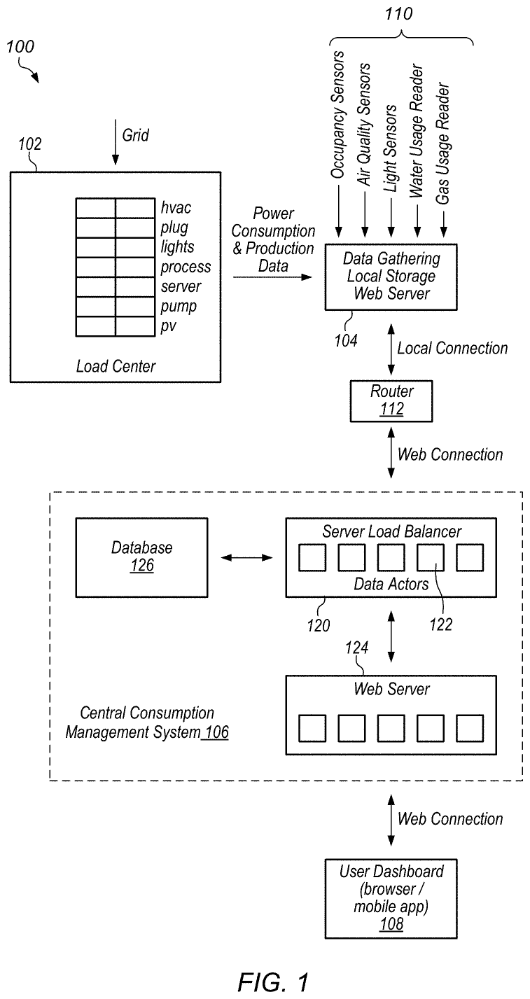

FIG. 1 illustrates one embodiment of a system for promoting lower resource consumption. System 100 includes load center 102, data gathering server 104, central consumption management system 106, and dashboard devices 108. Load center 102 and data gathering server 104 may be located in a home, building or other place where users of electricity and other resources (for example, water, gas or air) are located. Data gathering server 104 may be a local storage web server or data may be stored remotely. Load center 102 receives power from the electrical grid and distributes the power any of various loads, including HVAC systems, electrical outlets (plug loads), lights, processes, servers, pumps, and other electrical loads.

Load center 102 may transmit information about electrical power consumption to data gathering server 104. Data gathering server 104 may acquire information from sensors 110. Sensors 110 may be located at any suitable location for gathering information about conditions in or around the building or other place where a user is located.

Data gathering server 104 may be connected to router 112. Data gathering server 104 may exchange information with central consumption management system 106 via location connection to router 112 and a web connection.

Central consumption management system 106 includes server load balancer 120, resource consumption monitoring servers 122, web server 124, and database 126. Server load balancer 120 may balance loads for consumption monitoring servers 122.

Central consumption management system 106 may receive power consumption information and other information from data gathering server 104 for one or more places (e.g., buildings, floors, wings, factories, stores, or residences) or entities. In some embodiments, central consumption management system 106 receives information from data gathering servers at multiple places associated with an entity. For example, central consumption management system 106 may receive power consumption from data gathering servers at all of the buildings owned by a particular company, all the retail stores in a particular area, all the residences in a neighborhood, or all the buildings in an office park.

Information may be stored in database 126. Consumption monitoring servers 122 may perform computations, comparisons, and analysis based on information from data gather servers. Consumption monitoring servers 122 may generate displays to users, including individual users at places being monitored. Information for generating displays to users may be transmitted to user dashboard devices 108. Each dashboard device may display consumption information to a user at one or more places being monitored. In one embodiment, consumption information for particular space is displayed to users (for example, office employees) occupying that space. Resource consumption information from other locations may also be displayed, such that a person at one location can compare his or her consumption with that of other persons.

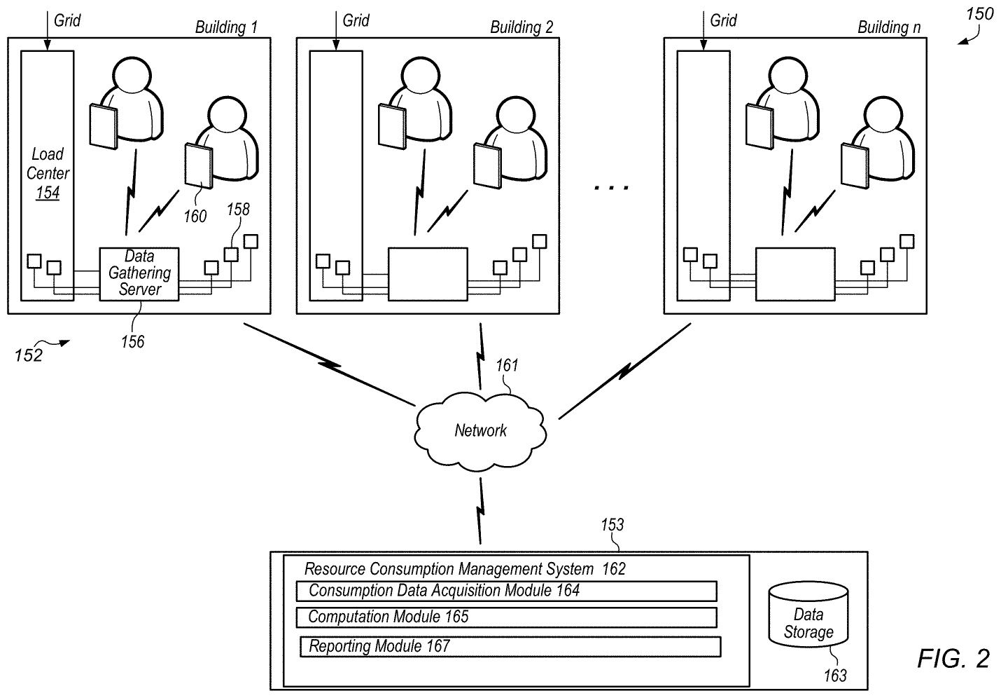

FIG. 2 illustrates one embodiment of a system that monitors and reports resource consumption information from multiple buildings. System 150 includes buildings 152 and central consumption management system 153. In some embodiments, each of building 152 is a residence. Each building 152 includes load center 154 and data gathering servers 156, and sensors 158. Employees at building 152 have dashboard devices 160. Load centers 154 and data gathering servers 156 may be located in a home, office, or other place where users of electricity and other resources (for example, water, gas) are located. Load center 154 receives power from the electrical grid and distributes the power to any of various electrical loads.

In the embodiment shown in FIG. 2, three facilities are shown for illustrative purposes. A system for promoting lower resource consumption nevertheless may in various embodiments acquire and report consumption information for any number of places. Resource consumption information may in various embodiments be tracked, analyzed, and reported on a building by building, floor by floor, or other basis.

Central consumption management system 153 may receive power consumption information and other information from data gathering server 156 for one or more places (e.g. buildings, floors, wings, factories, stores, or residences).

In some embodiments, a consumption management system is implemented in the form of components. For example, in one embodiment, central consumption management system 153 includes management system 162 and data storage 163. Resource consumption management system 162 may be coupled to devices, sensors and equipment at buildings 152 by way of network 161. Resource consumption management system 162 includes consumption data acquisition module 164, computation module 165, and reporting module 167.

Central consumption management system 153 may include one or more computing devices. In various embodiments, central consumption management system 153 may be provided by the same computing device or by any suitable number of different computing devices. If any of the components of central consumption management system 153 are implemented using different computing devices, then the components and their respective computing devices may be communicatively coupled, e.g., via a network. Each of the components may described above may include any combination of software and hardware usable to perform their respective functions. It is contemplated that a consumption management system may include additional components not shown, fewer components than described herein, or different combinations, configurations, or quantities of the components than described herein.

Resource usage measurement equipment, such as circuit sensors, may be provided in a system at suitable locations in each facility. In some embodiments, information is gathered for resource consumption measurement is gathered A system may include power consumption measurement devices at a circuit-breaker level. The system may measure various characteristics or conditions of a facility, or resource consumption rates.

Consumption data may be gathered and displayed in real-time. Granularity may be done in any increment. In one embodiment, reporting of consumption is granular to less than 0.5 seconds.

In some embodiments, a comparison of one entity's consumption of a resource is displayed to a person in the entity. The comparison is based on normalized values associated with consumption of the resource. In some cases, consumption by the entity is compared with consumption by the user at a different time or under different conditions (for example, a graph showing current consumption compared with consumption one year ago). In other cases, consumption of the entity is compared with consumption by one or more other entities (for example, a graph comparing the entities consumption for the week with that of other entities.) In some cases, consumption by the entity is compared with consumption goals or objectives set by the user or administrator. This highlights the difference between the actual energy consumption and the set objectives.

In some embodiments, a user is presented with a radial graph that includes a time-wise display of the user's recent consumption of a resource. The display may be presented on a person's office computer, at a central workstation or kiosk, or on a portable electronic device such as a notebook computer, tablet, PDA, or mobile phone.

In some embodiments, the user is an individual user, and the display of the user's own consumption is presented to the user. In other embodiments, the user is a group (for example, the occupants of a building), and the display is presented to two or more persons in the group. The individual user's energy consumption can be identified/estimated without specifically measuring each element that they use that consumes energy. This is accomplished by tracking when users remotely adjust specific load centers. For example, the system will track if a user request for more heat or light in the building and will therefore attributed that additional energy consumption to the individual. Additionally, specific local plug loads (such as desk lamps and computers) energy consumption can be estimated on a time determined basis and then these loads can be attributed to the individual user based on the number of hours the user is within the building.

In some embodiments, information about use of an energy-consuming resource is displayed in a radial graph display. The current level of consumption is indicated by the distance of an indicator (for example, a radially projecting bar) from the center of the display. The display is updated each half second by periodically sweeping around the graph, such as in the motion of a second hand on a clock. The radial graph may automatically scale based on previously collected data for a user such that the user can see both their typical energy consumption at this time period as well as show enough granularity to see small changes in energy consumption.

In some cases, the radial display may simultaneously display, in radial form, the consumption of other users (for example, other competitors in a game). Related information, such as savings, usage, bill energy, or game results, may be presented on the same screen with the radial graph. In some cases, results of a competition may be graphically displayed (for example, on a line chart) on the same screen as radial display.

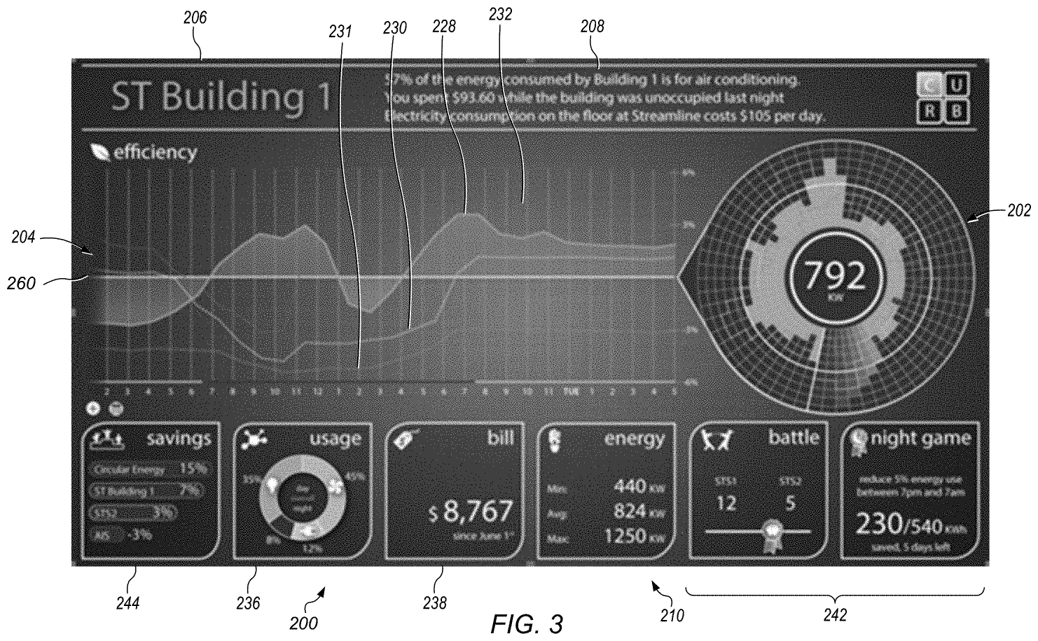

In some embodiments, a radial graph shows resource consumption information based on the motion of analog clock in which data is displayed over time by rotating clockwise. FIG. 3 illustrates one embodiment of a display having a radial graph of power consumption for a user. Display 200 includes radial graph 202, line graph 204, place identifier 206, summary panel 208, and usage information boxes 210 that can be tailored to specific clients needs.

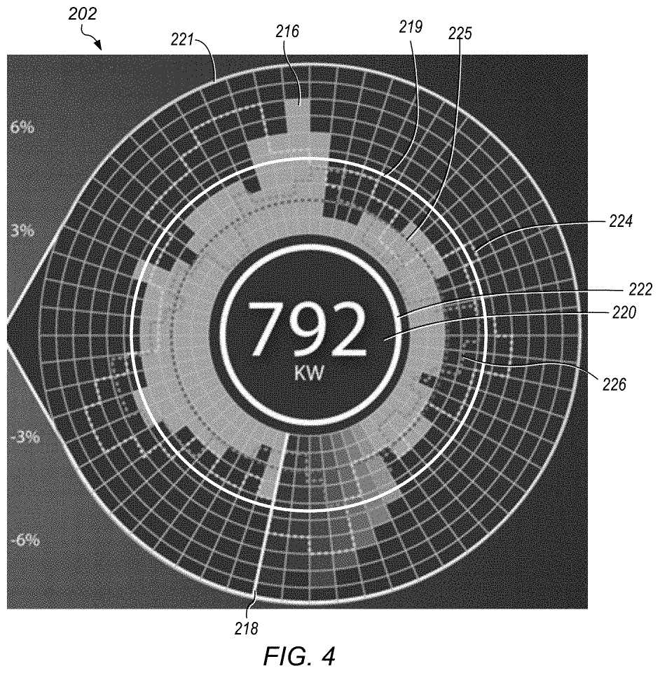

FIG. 4 is a detail view illustrating a radial graph that can be used to report resource consumption. Radial graph 202 includes bars 216, time indicator 218, baseline indicator 219, instantaneous usage readout 220, and heartbeat ring 222 (e.g., a resource “health indicator”). Current time indicator 218 may advance within circle 221. As current time indicator 218 advances around the circle, bars 216 may appear successively at the location of current time indicator. The length of each of bars 216 (as measured from the common base of the bars) may reflect the magnitude of power usage by the user during a one-second interval. For ease of viewing, the length of each bar 216 may be adjusted to precisely fill a column of boxes in a radial grid of circle 221. In certain embodiments, the consumption level for a user may be indicated by the level of light intensity, in addition to, or instead of the length of the consumption level indicators.

Baseline indicator 219 may show one or more base lines established for the user's consumption. Thus, in the illustration shown in FIG. 4, in the part of the graph where the shaded bars 216 are within the circle defined by baseline indicator 219, the user is used less power than the baseline level, while in the part of the graph where the shaded bars 216 project outside of the circle defined by baseline indicator 219, the user consumed power above the baseline level.

In some embodiments, values associated with consumption levels are scaled to make different conditions, circumstances, times, or entities to be comparable. In some embodiments, a user is presented with graphical information on the current usage and historical usage. The user may compare its own current usage versus historical consumption (for example, previous day, month, or year) or against a set goal or objective. A score algorithm may be applied to each competitor. Data may be normalized for the different conditions, circumstances, or times to make a useful comparison. In some embodiments, the system aggregates multiple inputs across multiple devices. The system can configure virtual inputs as values of other physical inputs (for example, A=B+C, A=B−C) and as factors of physical inputs (for example, A=0.3*B).

In some embodiments, data input is scaled such that the graph automatically zooms to show details of minor changes yet expands when increases exceed the graphs boundaries. The radial axis may automatically scale such that relative changes are very noticeable. For example, if over the course of a day if all of the change are within the 3000-4000 W range, the radial axis may only show 3000 to 4000 W and ignore the 0-3000 W range.

At the center of radial graph 202, instantaneous usage readout 220 a number indicates the instantaneous usage. The user may select the units for the reading to different units or equivalent measures, including kWh, dollars, or CO2.

In some embodiments, a radial graph shows usage of one or more other users. For example, in FIG. 4, plot 224 may represent a level of usage for another user an occupant or group of occupants of a different building during the same time period. In various embodiments, activity rings similar to heartbeat ring 222 may be implemented to indicate device health (e.g., appliance health) for any of the various devices being monitored. In some embodiments, activity rings such as heartbeat ring 222 may be implemented to indicate health of an entity or region of entities (e.g., the health of a group of appliances associated with an entity or region may be indicated).

Referring again to FIG. 3, line graph 204 is an x-y graph showing usage during recent time period, such as the preceding 24 hours. Plot 228 on the graph represents the user's own consumption. Other plots 230, 231, and 232 may represent consumption of other users during the same time period, by the same user at a different time (for example, the same period one year ago) or a specific targeted goal at that period of time.

In some embodiments, the colors of the graphs are configurable. For example, the user may be able to choose a color of bars 216, any of the plots on radial graph 202 or line graph 204, or both.

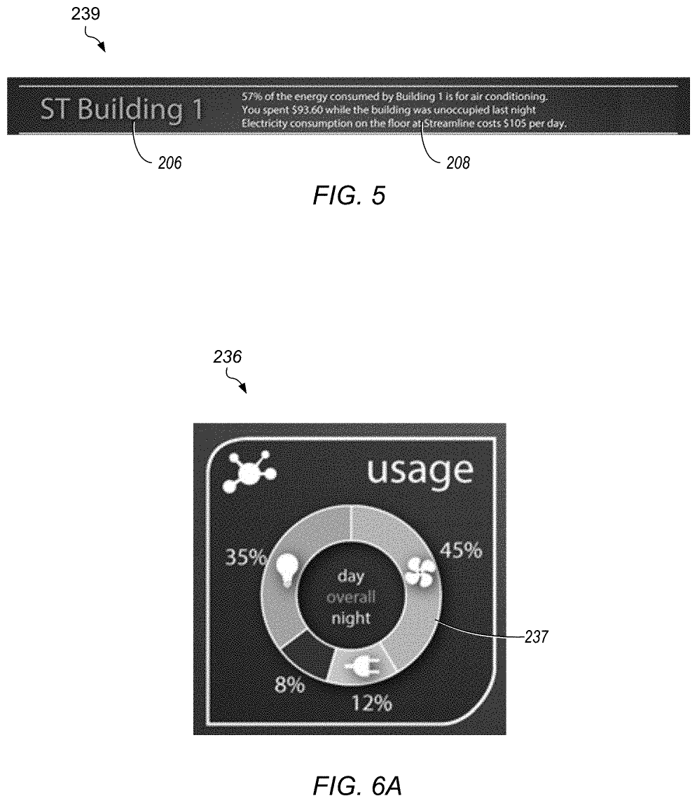

FIG. 5 illustrates a banner for a user display for real time power consumption by a user. Banner 239 includes place identifier 206 and summary panel 208. Summary panel 208 may provide information, status, or recommendations to a user to promote lower consumption of the resource being monitored. This banner can also alert users about specific resource events. For example, if a device is turned off/on or if the building is approaching a new peak consumption and then give users advice on how to avoid the peak.

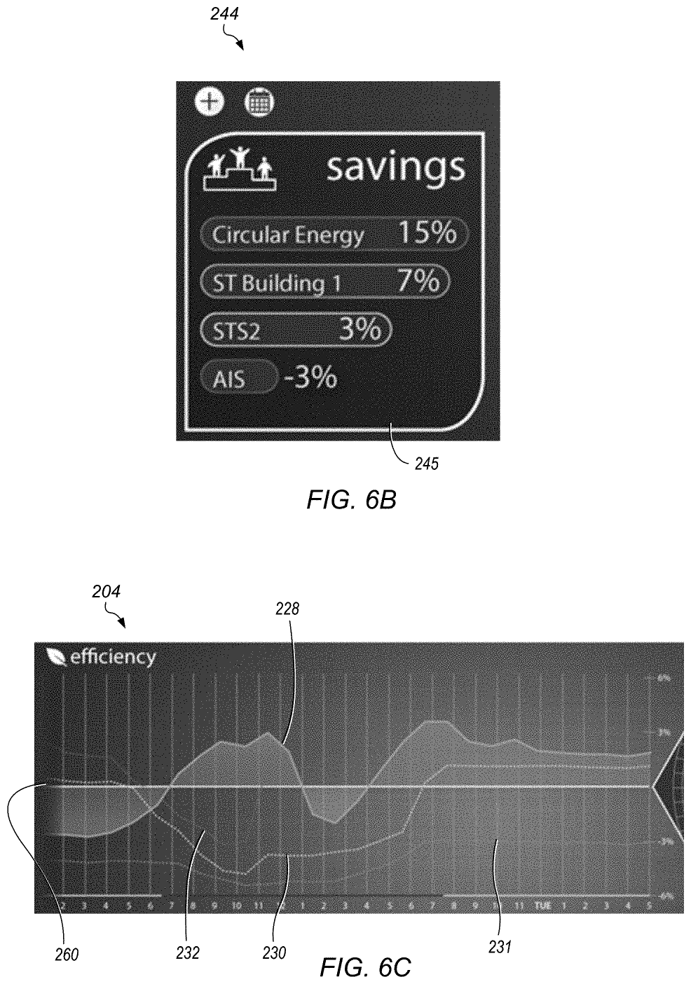

Usage information boxes 210 (from FIG. 3) include energy usage box 236, cost box 238, game status/results boxes 242, and savings competition results box 244. One or more of usage information boxes may include a pie graph. Over time period selected the pie graph shows the kwh and percentage of the different components of energy consumption. Center buttons (overall, day, night) change the pie graph to show consumption during night/day or both within the time period selected. FIG. 6A illustrates one embodiment of a usage box for a display. Usage box 236 includes pie chart 237.

FIG. 6B illustrates a competition results box for a competition among users. Savings competition results box 244 includes tabulation 245 that compares savings for each of four competitors in a game over various time periods (hour, day, week or month) configurable in the competition setup.

FIG. 6C illustrates a line graph showing results of a competition. Each of plots 228, 230, 231, and 232 show resource consumption rates for the 30 hour period preceding the time of the display. Plot 228 may show values reflecting the viewer's own consumption (or, consumption for the entity of which the viewer is a part.) Each of plots 230, 231, and 232 may show resource consumption for a different competitor. In some embodiments, plots in a line graph, a competition results box, and radial graph are color-coded (for example, orange for the competitor's own consumption or scoring, blue for Competitor A's consumption or scoring, red for Competitor B's consumption or scoring).

FIG. 6D illustrates a weekly report showing the status of a competition among teams. Report 250 includes team results 252 and graph 254 for each team in a company. The teams within the company may compete against one another in a game. Each team can review current results and usage for itself and the other teams in the competition.

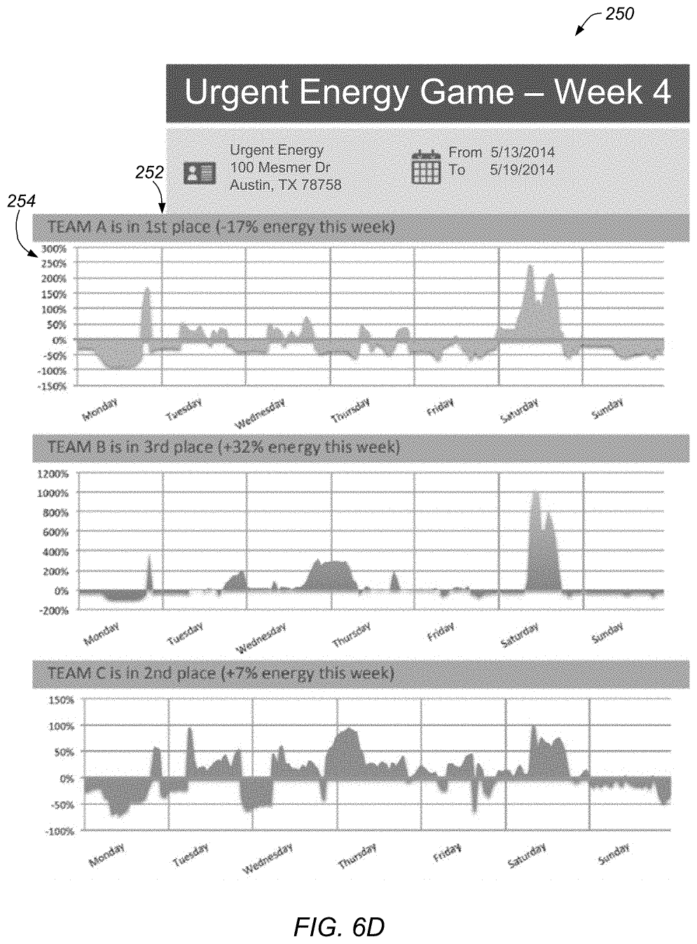

FIG. 7 illustrates one embodiment of a report showing a user's consumption and savings that can be displayed on a user device. Report display 700 includes summary panel 702, savings summary 704, weekly consumption graph 706, and consumption breakdown panel 708. Consumption breakdown panel 708 provides a breakdown based on different kinds types of loads, such as HVAC, plug loads, and other loads.

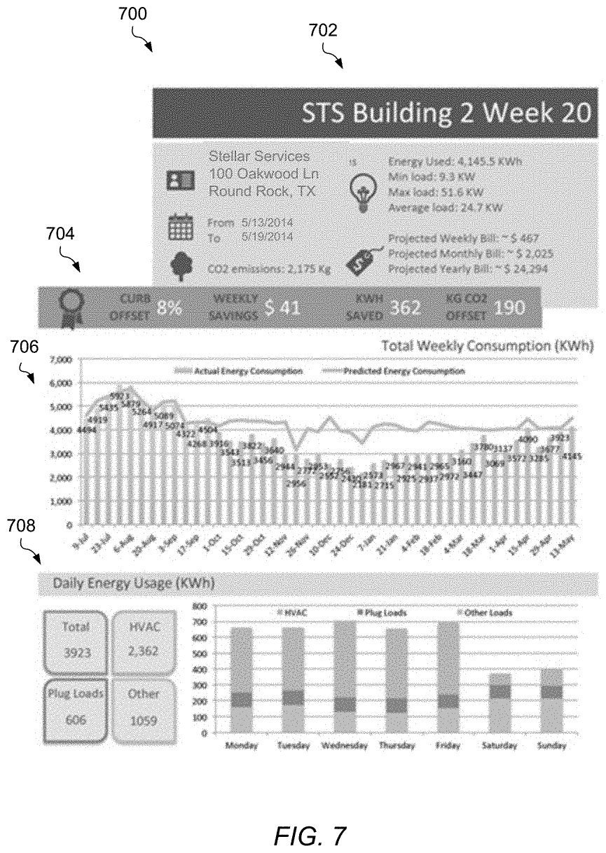

FIG. 8 illustrates one embodiment of a second report of a user's consumption and savings that can be displayed on a user device. Report display 820 includes savings tips panel 822, daily profile 824, and solar production summary panel 826. Daily profile 824 includes a graph showing lines for workday, weekend, and the day where the peak load occurred. Solar production summary panel 826 may graph solar production (for example, from photovoltaic cells) compared to the total consumption since the system was installed at a facility.

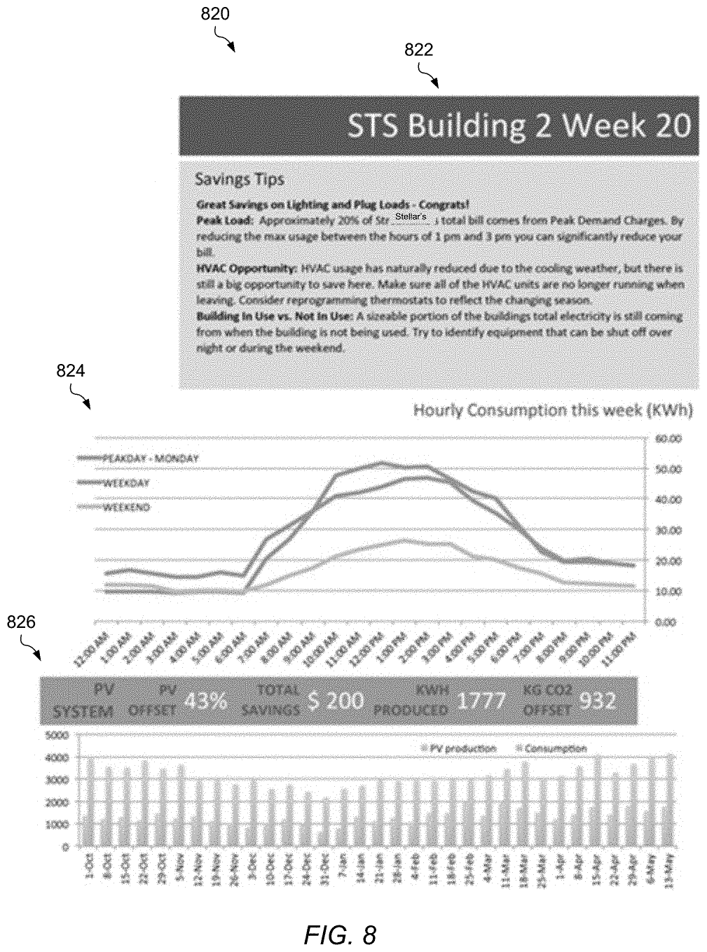

FIG. 9 illustrates a display of a historical view for resource consumption by a user. Historical view 940 includes graph 942. The graph may show all dates of the viewer's energy consumption. Consumption may be shown based on monthly, daily, hourly or minute intervals. The user has the ability to zoom in on any specific date in time (for example, by clicking and dragging the cursor). Plot 944 shows the actual resource consumption. Using this mechanism, the user can identify dates or times when more or less energy has been used. Line 946, plotted on top of the data, may indicate the projected baseline. The baseline m allows the user to see what the user's expected energy consumption is for a particular time frame.

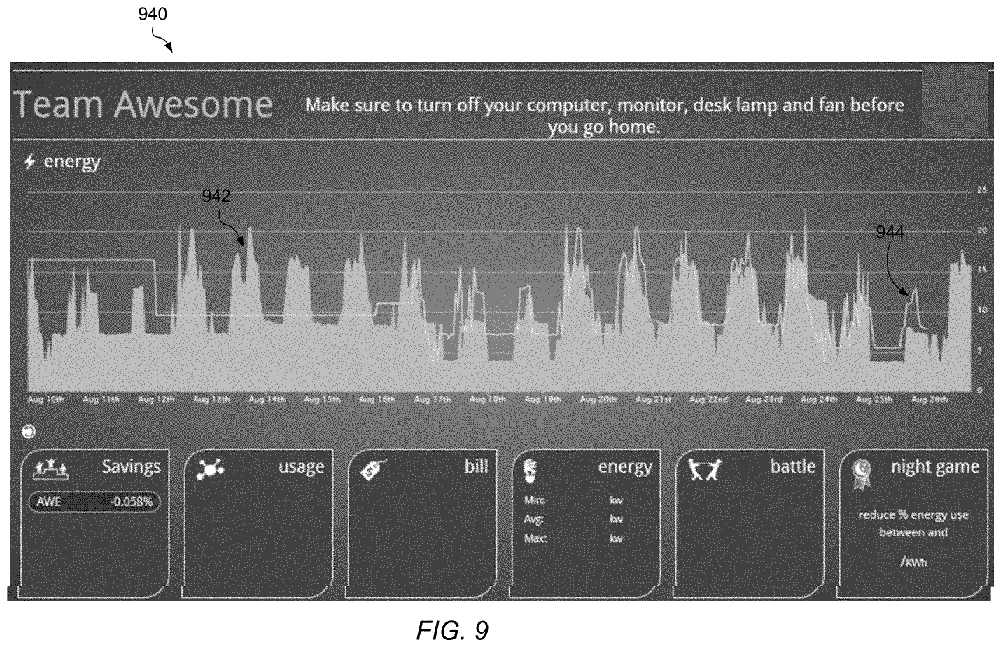

In some embodiments, a graphical display for providing information about consumption of a resource includes a user-selected set of widgets. FIG. 10 illustrates one embodiment of a set of widgets for a power consumption display. Each selected widget may display different information to the user. Widgets 1060 may be selected and arranged by a user. In some embodiments, widgets may allow a user to establish characteristic for a competition between other resource consumers. A menu or selectable list be provided to take input from a user to select competitors for a game, a type of game, a date or date range for a game, or other characteristics of a competition. In some embodiments, a widget provides results or user performance information, such as amount of energy saved, amount of energy offset by solar production.

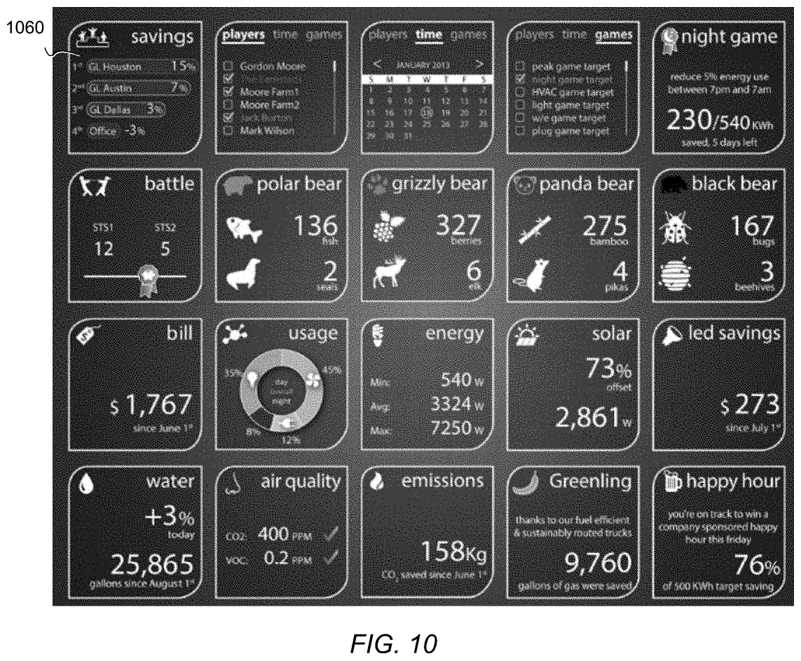

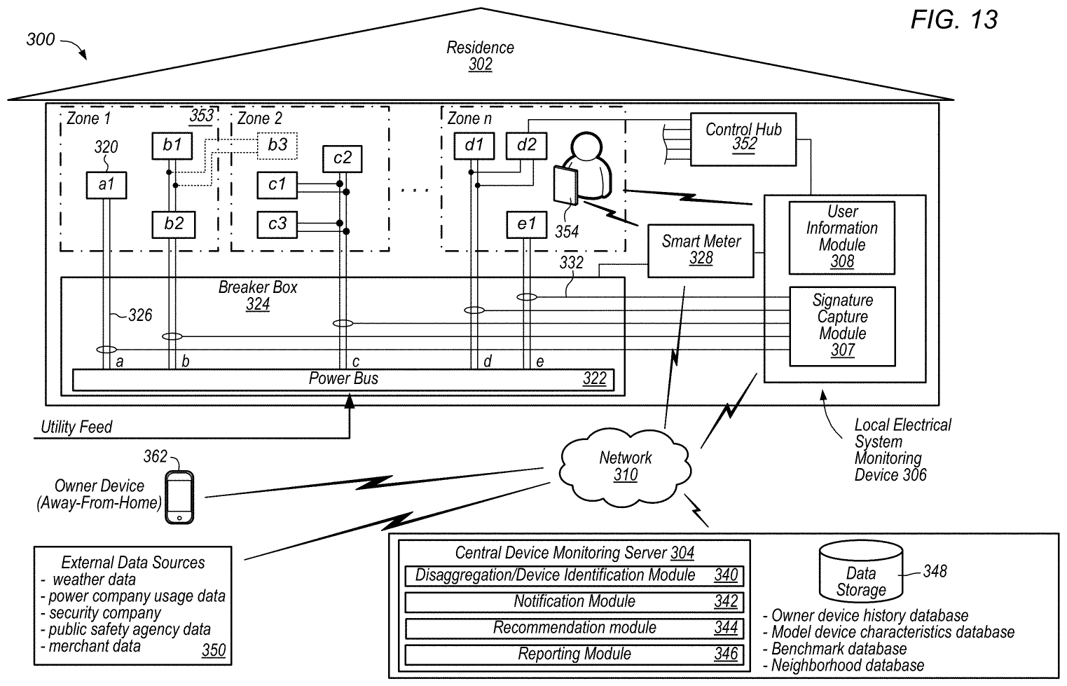

A radial graph may display power consumption information in real time. During operation, the graph is continually fed in 1 second intervals. Every time a second goes by, the total power draw from the interface is updated. In order to highlight which time segment is being updated, there may be a fading effect some segments ahead of the current one. For example, in one embodiment, the fading effect is applied to next 5 segments that ahead of the current consumption indicator. FIGS. 11A through 11C illustrate a radial graph display at different times over a 29-second period. FIG. 14A is at time=x:39. FIG. 11B is at x:53, a point in time 14 seconds after the time of FIG. 11A. FIG. 11C is at (x+1):08, a point in time 15 seconds after the time of FIG. 11B.

In some embodiments, a system displays an indicator that has one or more characteristics analogous to a physiological indicator. The physiological indicator may represent resource consumption by the user. In one embodiment, the display includes an indicator that pulses like a heartbeat.

In some cases, a display includes one or more energy consumption indicators that are suggestive of physiological indicator. In one system, for example, a circle or ring on the display flashes on and off as a “pulse rate” suggestive of a heartbeat. A higher pulse rate indicates a high level of energy consumption, while a lower pulse rate indicates a lower level of energy consumption.

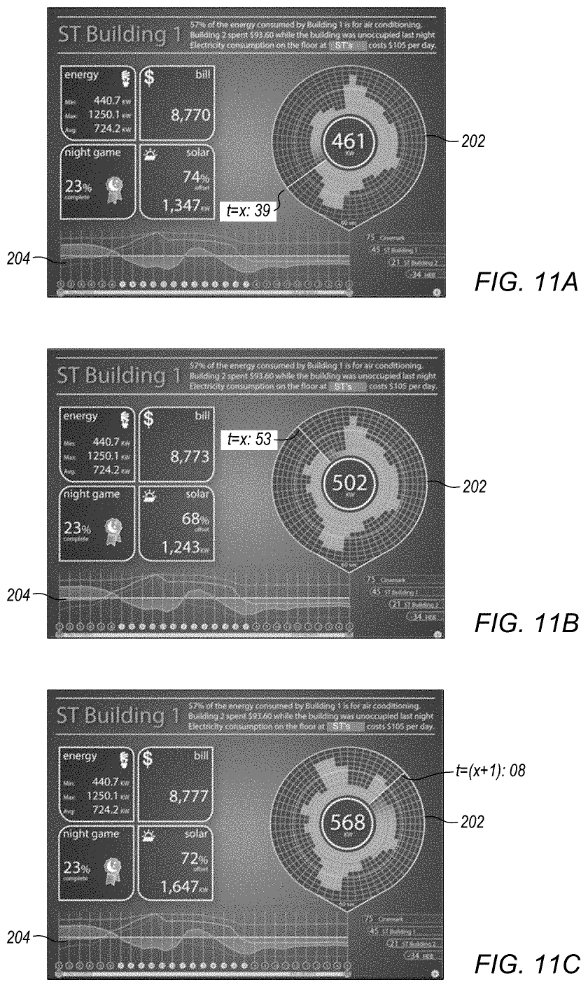

FIGS. 12A and 12B illustrate a display including a heartbeat visual indicator in a radial graph of power consumption. Heartbeat ring 222 is included at the center of radial graph 202. Heartbeat ring 222 pulses such that the ring dilates and contracts on the display at a rate similar to that of a human pulse. For example, at time=x:05, the ring may be at a dilated state as shown in FIG. 12A, while one second later at time=x:06, heartbeat ring 222 may be at a contracted state as shown in FIG. 12B. The rate of pulsing of heartbeat ring 222 may correspond to a rate of consumption by the user. As consumption increases, the pulse rate increases in manner suggestive of a heart under stress (for example, while exercising). As consumption decreases, the pulse rate may decrease to a rate suggestive of the heart rate of a person at rest. In this manner, the view of the display may present a continuous indicator of whether the user's consumption is at a relatively high level, moderate level, or a relatively low level. The pulse rate may also change based on the normalized consumption such that high pulse rates only occur when the energy consumption is much higher than the typical energy consumption at that time. (For example a high pulse would result from light being left on in the middle of the night). The actual energy consumption may be low but it is much higher than the typical energy consumption at that time period. Examples of other physiological indicators include shivering, wheezing, or breathing intensity. Units of energy (kWh) or power (kW) in the display are not typically well understood by most individuals. Additionally, the absolute values of these factors are not typically reviewed so there is little reference to know if a particular power consumption is high or low. By using physiological display methods, an untrained user may be able to intuitively understand if the building is using too much energy (typically illustrating waste) and may thus be more motivated and have information to correct the situation.

As noted above, the display may include information about other users' power consumption in addition to the user.

In some embodiments, users may participate in a games or competitions with one another. The display may provide information about how the user is doing in the game relative to other competitors. Referring again to FIG. 4, bars 216 in radial graph 202 may represent power consumption by the “home” team while the overlay plots 224, 225, and 226 may represent power consumption the competition (in this case, three other competitors). Displaying information of the user and other users on the same graph may show the user how it is doing in comparison to the other users in the competition. Information on how the user is doing in comparison to competitors may motivate the user to reduce its energy consumption. In some embodiments, plots 224, 225, and 226 are color-coded (for example, orange for the competitor's own consumption or scoring, blue for Competitor A's consumption or scoring, red for Competitor B's consumption or scoring).

Line graph 204 may show who is winning a cumulative game. In FIG. 6C, plot 228 represents consumption by a user, while each of plots 230, 231, and 232 represents consumption by a different user (a competitor in the game). The values represented by the lines may be normalized with respect to one another. For example, if User A is a café and User B is an aircraft manufacturing facility, the values may be normalized to create a fair competition for reducing energy consumption between User A and User B. Each hour of the last 24 hours is normalized independently.

Base line 260 (in this case, the x-axis on line graph 204) may represent the baseline or expected consumption for the user to which the graph is being displayed. For example, if the user's line is above base line 260 then the user may be consuming more energy than they typically did historically in that hour. Historical data comprising the baseline can be from the previous day, week, months, year or some algorithmic combination of each of these time periods. In some embodiments, the background is highlighted in different colors above and when below base line 260. For example, the background may highlight red (like a stoplight) when plot 228 is above base line 260, and highlight green when plot 228 is below base line 260.

Values may be scaled to make competitor scores comparable. A score algorithm may be applied to each competitor. Data between competitors may be normalized such that two entities can compete on an even footing. Normalized data inputs such that minor changes in behavior result in sizeable changes in the competition. The system may aggregate multiple inputs across multiple devices. In some embodiments, the system aggregates multiple inputs across multiple devices. The system can configure virtual inputs as values of other physical inputs (for example, A=B+C, A=B−C) and as factors of physical inputs (for example, A=0.3*B).

In some embodiments, an administrator page allows input an hourly normalized score for each competitor. Different profiles (in office/out of office) may be automatically selected based on administrator-selected criteria, such as the day of the week. For example, different profiles may be provided for weekends and week days. The System Administrator page may allow user to select profile for different days in advance or set a weekly or monthly or yearly patterns.

In some embodiments, the system allows a social comparison to inspire competition between teams or individuals. A relative comparison may be done to provide context about what is normal. A scoreboard may show each view how they are currently doing when compared to his or her competitors. This will show, for example, who is “winning” the current day such that individuals are incentivized to change their current behavior. The display may provide a connection between the real time graphs that are updated each second and the leader board which reflects the score over the month.

Using the system, gamification of consumption monitoring among two or more user competitors may be managed. Gamification may encourage individuals to change behavior based on, for example, winning badges, changing colors, or beating their peers. A gamification may be chosen to get greater engagement from employees or other building occupants (such as residents). The system may target specific opportunities to reduce wasted energy.

In some embodiment, the system allows an administrator to select from a set of games of varying lengths. For example a system may support short term games (for example, hourly, weekly) and longer term games (for example, quarterly, seasonal, or annual). The time frame of any game may be selected to maintain engagement or focus on reducing billed amount. Short term games may roll up in to long term game using the points system.

Games may include a set of teams and individual awards. User profiles may be established and maintained for each team and individual. The system may enable links and ability to post on outside social media sites (for example, Facebook™, Linked In™, or Twitter™) Individuals may keep track of their points. The points of one team member may differ from other team members because of other challenges, objectives, interactions, or previous team challenges.

In some instances, specific game mechanics shall be deployed that where users risk losing the points they have earned if they do not adjust their resource consumption behavior. This creates a different kind of motivation as opposed to gain points which has been found to have an extremely impactful result on encouraging a specific type of behavior.

The following are examples of characteristic that may be included in games managed by the system.

Game Example 1:

Monthly Leader Board:
1) The objective of the monthly leader board is as follows:
   1) Illustrate how teams are progressing over time
   2) Provide a summary of the competition
2) Each day a winner is decided based on configurable characteristics. Example characteristics:
   1) greatest percent reduction from average
   2) greatest absolute reduction from average
   3) greatest progress toward goal

Game Example 2

Example of Gamification Mechanics and Details:

Rules

Time frame: Games are configurable to last different time

Objective: Team with the most points wins the competition

Rewards:
Levels—change your color based on # of xxx earned
   Points—X points to get to the next levelXxx can be points, kwh, dollars, etc.
Badges—based on completing specific missions/games (based on anything, not just points)
   Can be team or individual specific

Levels:
Levels are adjustable for each game setup to encourage involvement
only the current level points need may be shown so that next level points can be modified

Level 1: 1000 pts

Level 2: 2000 additional pts above level 1

Level 3: 3000 additional pts above level 2

Level 4: 4000 additional pts above level 3

Level 5: 5000 additional pts above level 4

Level 6: 6000 additional pts above level 5

Level 7: 7000 additional pts above level 6

Example Game Scoring System:

| Objective | Points | |
|---|---|---|
| Win an hour | 10 | pts |
| Win a day (extra points) | 200 | pts |
| Win a month (extra points) | 10,000 | pts |

Example Short & Long Term Games:

| Objective | Points | |
|---|---|---|
| Reduce Peak level: (DAILY) Team who | 300 pts, Peak Badge | |
| reduces their Peak demand in a 24 hr cycle | | |
| by the greatest percentage over their | | |
| historical level | | |
| Reduce Base Level: (DAILY) Team who | 300 pts, Base Badge | |
| reduces their Base consumption level in a | | |
| 24 hr cycle by the greatest percentage over | | |
| their historical level receives a point. | | |
| Reduce HVAC Load: (DAILY) Team | 300 | pts |
| who reduces their HVAC consumption | | |
| level in a 24 hr cycle by the greatest | | |
| percentage over their historical level | | |
| receives a point. | | |
| Reduce After Hours Load: (DAILY) | 300 | pts |
| Team who reduces their After Hours | | |
| consumption level in a 24 hr cycle by the | | |
| greatest percentage over their historical | | |
| level receives a point. | | |
| Reduce from Previous Week Recorded | 2,500 | pts |
| Value: (WEEKLY) Best overall | | |
| Set Value Challenge: (DAILY) | 300 | pts |
| Reduction from previous days' | | |
| consumption by a set percentage. Winner | | |
| is determined by who exceeds to set value, | | |
| if both teams reduce by the set level, extra | | |
| points are awarded to the team that does | | |
| better overall. | | |

| | |
|---|---|
| Monetary Goal Challenge: | 300 pts daily, |
| (DAILY/WEEKLY) Special event | 2,500 pts weekly |
| challenge that allows competitors to | |
| compete together for energy savings. | |
| Savings for the time frame can be applied | |
| to charity donations or office parties. | |
| Points awarded to all participants. | |

In some embodiments, a user can select the competitors to be included in a competition. For example, a company may be able to select which other companies it will compete against. As another example, a residential user may be able to pick which neighbors the user will compete against in a game. In some embodiments, the system may present the user with a drop-down menu that allows the user to select competitors from the menu.

In some embodiments, a system gathers and displays information about use of an energy-consuming resource, such as an air-conditioning system, to a user of the resource, while the resource is being used, based on one or more benchmarks determined by the system. In some cases, information is displayed to the user in real-time. The user of a resource may be an individual or a group of individuals (for example, all of the occupants or a home or office building or an entity as described herein). Users or entities may be motivated to reduce energy consumption based on the information displayed.

In some cases, an entity's consumption level may be compared to one or more other entities. For comparison purposes, each entity's consumption may be normalized based on each entity's past consumption, weather (either historic, current, or predicted), building size, number of occupants, and age of construction. For example, each entity's consumption may be normalized based on what that entity was consuming during some previous time period (for example, a one-hour time period 24 hours ago, or 7 days ago).

In some embodiments, a system gathers and displays information about use of an energy-consuming resource, such as an air-conditioning system, by one or more users of the resource (e.g., one or more entities). The information provided to the system is analyzed. Patterns may be identified for particular users or entities. Based on the information gathered and learning by the system, each user/entity may be presented with suggestions on how to reduce energy consumption. A user/entity may also be assigned goals or targets for reducing consumption.

In various embodiments, the information gathered and learned by the system includes multiple inputs. Inputs that may be considered by the system include, but are not limited to, user inputs (such as inputs from multiple different users), external temperature variations (e.g., historic or predicted weather conditions), device properties (e.g., cooling/heating capacities for HVAC equipment), residential/building area (e.g., usage of a geographically-defined area of the user/entity), and peak usage (e.g., peak demand for the utility provider of the user/entity). In some embodiments, the user inputs may include multiple inputs from multiple different users and the system may “democratically” assess the inputs to determine suggestions or profiles for energy/resource consumption. For example, each user's input may count as one vote though some embodiments may contemplate weighting of different users' votes (such as a primary user getting a larger weight to his/her vote).

In some embodiments, a user is presented with a display showing a comparison of the user's goals with actual consumption. In one embodiment, a user display includes a line graph showing a plot of the user goal versus actual consumption as a function of time. The differences between goal and actual consumption may be highlighted. For example, if the user is outperforming the goal, the period of outperformance (e.g., above the baseline) may appear shaded in green on the graph, while a period of underperformance (e.g., below the baseline) may be shaded in red on the graph.

In some cases, the system identifies and tracks specific devices/systems based on load signatures. For example, based on characteristics of the load when the unit is switched on, the system may identify that a particular type of air-conditioning unit is being operated. Goals or recommendations may be tailored using the information about how and when particular devices/systems are being used. Recommendations may also be displayed based upon the level of success achieve from previous recommendations. In some embodiments, a system performs predictive analysis based on collected energy use data.

In some embodiments, one or more baselines are established for a user. The baseline may be used to identify where there are opportunities for reduction of wasted resource consumption. Examples of factors and systems that may provide opportunities for reduced consumption include unoccupied building loads, HVAC, and lighting. The system may automatically identify opportunities.

In certain embodiments, a system compares a hypothetical perfect building to particular building and identifies waste within different processes and mismanagement. Historical usage may be reviewed to identify trends or anomalies within a particular entity's consumption as compared to its competitors.

In some embodiments, a baseline is established by assessing optimum or minimum usage for a place based on selected past measurements of consumption in the place. To establish the baseline, an interval of interest, such as 24 hours, may be selected. Data for a historical period, such as consumption over the last year, may be analyzed to identify optimum or minimum energy usage. For example, minimal usage points may occur at certain times of day, when no one is in the building. Minimum values may be used to establish a baseline value. The baseline values may provide a user with an indication of how well the user could be doing in its level of consumption. The system may update the baseline based on learning from additional minimum data points as the system operates.

In some embodiments, triggers are established based on specific electrical signatures of components or systems in a place where consumption is being monitored. An electrical signature may be based on, for example, electrical load characteristics of power consuming system, such as an HVAC system. A notification may be displayed to a user when a specific load at the user's location is switched on or off.

An event ticker may be used to distinguish and highlight events that have a large effect on the energy usage. For example, turning on a set of lights may register an increase of 500 watts, the event ticker would read “Bay Lights On”. The ability to determine the increment amount (i.e. 1 W, 5 W, 20 W, or 500 W) may be dynamic. The label that is attached to them may be configurable.

A value related to the threshold change in power may be configurable within the administrative settings so that only changes of a specific magnitude trigger a ticker event. For example, with a trigger of 300 W, a 100 W change might not trigger any events tickers, but a change of 500 W would trigger the review of table and the event “bay lights on/off”.

During the on-site configuration of a particular entity, an initial table of Events and Values may be developed. The table should have the ability to be updated remotely as greater insight into the energy consumption become available. Table 1 shows an example input structure.

TABLE 1
Example of Configuration Events for Ticker

| | | Time | | | |
|---|---|---|---|---|---|
| Change | Tolerance | Period | Tolerance | Event | Color |
| 500 | 10 | 1 | 0.5 | Bay Lights | Yellow |
| 3 | 1 | 5 | 2 | AC Fan | Yellow |
| 800 | 200 | 1 | 0.5 | Compressor | Orange |

Each input may have its own Event Table with X rows for specific events. If two events have very similar load signal or “value”, a physical reconfiguration of the monitoring device may be necessary to break the two different events into different inputs.

In some embodiments, a system allows group of users to control an energy-consuming resource by allowing each user cast a vote. For example, each occupant of an office building may vote on what temperature to set a thermostat at or whether to raise or lower the setting on the thermostat.

In some embodiments, the operating settings for the resource may be determined by an algorithm based on the combined input of the users in the group (rather than, for example, the noisiest member of the group). Patterns of each user may be tracked, and a user's changes attributed to total energy consumption (for example, the user's contribution to the energy bill). Users may be provided with feedback to promote reduced energy consumption. In some cases, a user is presented with options to offset the user's energy usage with energy-saving measures, such as turning off the user's lights or printers. In certain embodiments, the system may provide suggestions on an action to offset the effect of the user's choices.

In an embodiment, a system allows users to control the HVAC system by casting a vote about their thermal comfort. Specific users' patterns may be tracked. A change in the energy bill (projected or actual) may be attributed the user's vote. If a particular user's vote had the effect of increasing consumption, feedback may be provided to users. The feedback may include suggestions on an action to offset the effect of the user's vote.

In many embodiments described above, information is related to energy consumption. A system may nevertheless, in various embodiments, incentivize any behavior. Examples of objectives that may be promoted using games or user comparison displays such as described herein include ecological footprint, green initiatives, cultural improvements, environmental quality, and marketing. Additionally, objectives can be surrounding improved health for building occupants by changing air circulation patterns or changing the air chemistry, composition, or filtration levels.

In one embodiment, a system presents the owner or occupant of a home with information comparing environmental quality. Characteristics of the facility that may be monitored, compared and reported include natural light, indoor air quality, carbon dioxide levels, VOCs, acoustics, and thermal comfort. Promoting or optimizing environmental quality characteristics may be included in a game between occupants of different places. For example, the occupants of one building on a company campus may compete with occupants of other buildings to reduce carbon dioxide levels. Each building may be provided with sensors, instrumentation, and monitoring devices (for example, carbon dioxide sensors, acoustic meters) to supply data about conditions in the home.

In some embodiments, a score associated with ecological impact or environmental impact is determined for an entity, place, or both. The score may be a composite score based on multiple factors. For example, the system may compute an ecological impact or environmental impact score for occupants of an entity (e.g., a building) that is based on a composite of values for each of air, water, gas, energy, light quality, or a combination of two or more such factors. The ecological impact or environmental impact score for an entity may be normalized (as described herein) for comparison to scores of other entities. In various embodiments, a system (as described herein) may generate suggestions or controls for an entity to reduce the entity's ecological impact or environmental impact score.

Home Intelligence System with Disaggregation and Device-Specific Notification

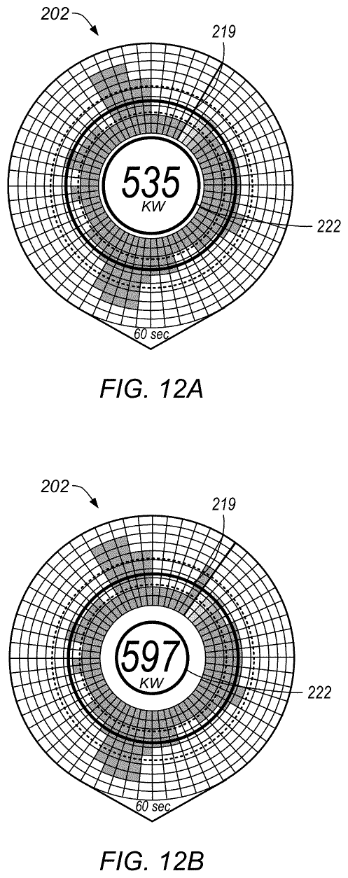

FIG. 13 illustrates an embodiment of a home intelligence system that includes a local device that captures energy consumption as well as electrical signature data such as: phase angle, voltage, current, frequency modes, amplitudes, and all other digital and analog characteristics related to the electrical signature of the devices within the home. The local electrical system monitoring device is connected, via a network, to a remote server that further processes and uses information acquired by the signature capture device. In some embodiments, the remote server is provided through cloud computing services, in other embodiments all of the process is completed locally.

Home intelligence system 300 can provide information to a homeowner of residence 302. Home intelligence system 300 includes central device monitoring server 304 and local electrical system monitoring device 306. Local electrical system monitoring device 306 includes electrical signature capture module 307 and user information module 308. Central device monitoring server 304 is connected to local electrical system monitoring device 306 over network 310. Network 310 can be any communication channel including all wireless and wired channels used in the communication of data. Central device monitoring server 304 may be at a location remote from residence 302. Electrical signature capture module 307 captures signal information from power lines in residence 302, which can be used to determine electrical signatures for electrical devices in residence 302. Local electrical system monitoring device 306 may exchange information with electrical devices operated by a homeowner or other resident. Such electrical devices may include, in various embodiments, a desktop PC, a tablet computer, phone, smart television, or a dedicated energy consumption display portal device.

Local user information module 308 may determine information to be displayed to, and receive input from, homeowners, residents, or other occupants of residence 302. Information generated for a user may include power consumption information and other information about electrical devices, which may be on a zone-by-zone and/or device-by-device level, notifications about electrical device conditions, and recommendations. In some embodiments, local user information module 308 manages control signals for specific electrical devices from residents, the homeowner, central device monitoring server 304, or other external components.

For illustrative purposes, only one residence is shown in FIG. 13. A central device monitoring server may, however, be connected to, and provide external data computations, analysis, monitoring, and reporting for, any number of residences. In some embodiments, a central device monitoring server 304 provides monitoring for numerous members or subscribers in a neighborhood, city, or other area.

Electrical devices 320 may be distributed through various locations in residence 302. Power bus 322 in breaker box 324 may receive power from a utility feed and distribute the power to various ones of electrical devices 320. Each device 320 may receive power by way of one of circuits 326. Electrical devices 320 may be one of various electrical devices in or at a residence, including a refrigerator, dryer, lamp, plug load, stove, pool pump, porch light, or other device. In FIG. 13, for illustrative purposes, power is supplied to electrical devices 320 by way of one circuits a, b, c, d, or e. Each of circuits a, b, c, d, or e may correspond to one circuit breaker in breaker box 324.

Smart meter 328 may monitor power distribution to some or all of electrical devices 320 Smart meter 328 is linked via a network to central device monitoring server 304.

For illustrative purposes, five circuits (a, b, c, d, and e) are shown in FIG. 13. A home intelligence system may, however, measure electrical signals on any number of circuits (1 to n circuits). In certain embodiments, a home intelligence system may be connected to power distribution components in more than one location (for example, breaker boxes in each of two different locations in a home).

Electrical signature capture module 307 may include a control module to turn circuit breakers on and off and a power sensor array 332. Power sensor array 332 may include a sensing device for each of circuits 326. The sensor may be, in one embodiment, current transformer (CT) loops or Rogowski coils. The CT may be coupled to conductors for each of the corresponding circuits. In various embodiments, power sensor array 332 may sense current, voltage, and/or other characteristics of power being distributed to electrical devices 320. Signature capture module 307 may acquire signals from conductors in power circuits 326 and perform some or all processing of the signals for determining electrical signatures for some or all of electrical devices 320.

In one embodiment, electrical signature capture module 307 may convert signals from power sensor arrays 332 from analog to digital data. As further described below, signature capture module 307 may perform signal processing of the digital data, such as a Fourier transform. Local electrical system monitoring device 306 may transmit information to central device monitoring server 304. The transmitted information may be a combination of raw signals acquired from power sensor array 332, values computed in signature capture device, or combinations of both.

Central device monitoring server 304 includes disaggregation/device identification module 340, notification module 342, recommendation module 344, reporting module 346, and data storage device 348. Data storage device 348 may include databases used by the central device monitoring server 304 to perform disaggregation, generate notifications and recommendations, and perform other tasks for the home intelligence system 300. Central device monitoring server 304 and all modules (340, 342, 344, 346, and 348) may all reside within the signature capture device or they may reside in another location on the residence premise, or they may reside in a remote location.

Central device monitoring server 304 may access information from databases and external information sources over network 310. The accessed information may be used for disaggregation, notifications, and recommendations. Examples of databases that may be accessed from a central device monitoring server include, in various embodiments:

Owner device history database. An owner device history database may include historical data about signals, characteristics, power consumption and performance data of specific devices in a residence. The system may track and analyze trends in use of specific device. The trend data may be used, for example, to assess the likelihood of failure of a given device and, if appropriate, provide a warning to the resident of such failure.

Model device characteristics database. A model device characteristics database may include model signatures or profiles of particular types of devices (e.g., an air conditioner, a pool pump, or dryer, or a television set. The model device characteristics database may be used by the system to determine the type of one of electrical device. This database may be specific to types of devices (resistive, inductive, capacitive, etc. . . . ) or may be specific to the function the devices perform (heating, cooling, lighting, charging, etc. . . . ) in order to help assist the system in determining what kind of device is on/off and the amount of power that it uses.

Benchmark database. A benchmark database may include information on performance or signature characteristics of particular types or models of devices. For example, a benchmark database may provide how much power a particular model of air conditioner typical consumes at a given age and for given set of weather conditions (e.g., temperature, humidity).

Regional database. A regional database may include information about electrical device usage, performance, or characteristics for a defined area, such as a neighborhood, zip code, city, state. The regional database may be used, for example, to generate statistical comparisons between the consumption patterns of a device in one residence versus that of similar devices owned in other residences in the same region. Regional data may be current data or historical data. In certain embodiments, regional data is provided to the system in real-time. For example, the system may generate comparisons of current power consumption by air conditioners in residences in a particular neighborhood.

In some embodiments, central device monitoring server 304 accesses or exchanges information from external sources 350. Data from external sources may include weather data, power company usage data and merchant data (such as specific devices on the marketplace that may benefit the customer). In some embodiments, a central device monitoring server 304 exchanges information with a security company or public safety agency.

In some embodiments, a central device monitoring serve receives data from providers of goods and services. Data from a goods seller may include, for example, information about items that could be purchased from the merchant to replace a component in a residence that has been found to be failed. In some embodiment, the information provided by the merchant includes the terms of promotions or sales offered by the merchant for a replacement product.

Central device monitoring server 304 may use information received from electrical signature capture module 307 to disaggregate devices 320 of residence 302. For example, central device monitoring server 304 may use signals acquired from circuit a to compute an electrical signature for electrical device a1, signals acquired form circuit b to compute electrical signatures for electrical devices b1 and b2, signals acquired from circuit c to compute electrical signatures for electrical device c1, c2, and c2, and so on.

Central device monitoring server 304 may also be configured to identify a type, class, or model of each of devices 320 based on an electrical signature. For example, system 300 may determine that device a1 is a refrigerator is an electric stove, device b1 is a refrigerator and, and device b2 is a coffee machine.

Electrical devices 320 that have been identified by the system may be grouped into zones 353. In some embodiments, each zone may correspond to electrical loads on a particular one of circuits 326.

In some embodiments, each zone corresponds to a particular room of the house. For example, the system may establish a kitchen as one zone, a living room as another zone, and master bedroom as still another zone, and so on. In some cases, one room may correspond to two or more zones, or a zone may cover two or more rooms. In some cases, a zone includes parts of two or more different rooms.

In some embodiments, each zone corresponds to a functional area, for example, the entertainment part in living room, the exercise area in a garage, or the home office in a study. In some embodiments, groups or zones may be established based on functional criteria. For example, one group or zone may be established for all of the entertainment devices, all of the lights, all of refrigerators, all of the exercise equipment, or all of the pool equipment.

In some embodiments, user information module 308 receives notifications generated by central device monitoring server 304 and deliver to an owner device 354 in residence 302. In some embodiments, the owner device is a portable electronic device, such as a tablet computer or mobile phone. The notifications may provide an owner with information about power usage of various electrical devices in the residence, which devices are on/off, warning about failures or potential failures, and anomalous conditions (e.g., a garage door is open when it is not expected to be).

Control hub 352 may be connected to various electrical devices 320 (or circuits a, b, c, d, or e) in residence 302. Control hub 352 may control various ones of electrical devices 320. Control may include actions such as switching a device on or off, adjusting a level on the device (e.g., thermostat setting), or changing a mode of operation. In some embodiments, switching devices are interposed between power receptacle and a plug for the device to be switched the power switch may receive a signal from control hub 352. The switching device may be connected to the control hub 352. Signals from control hub 352 to various electrical devices 320 may be wired, wireless, or combinations thereof.

Owner device 362 may allow an owner to control and/or monitor electrical devices from a location away from the residence. In one embodiment, owner device is a smartphone.

In some embodiments, a control hub receives switching signals for an electrical device in a residence from a remote source. For example, control hub 352 may receive, via user information module 308, an instruction from owner device 362 to turn off a device (for example, an air condition in Zone 2). As another example, control hub 352 may receive, via user information module 308, an instruction from central device monitoring server 304 to turn off a device (for example, an air condition in Zone 2).

Control hub 352 may store and manage a set of conditions that can be set by the user or manager of the system to trigger devices to turn on/off or otherwise change state. One of the conditions that can trigger the control hub is the state (on or off) of any of the devices a1, b1, b2 . . . n #. For example, the control unit could be setup to turn off the porch light of a home when the resident goes to sleep. The control unit knows that the resident has retired to go to sleep because central device monitoring server 304 can tell the state of the bedside lamp in the bedroom. When this bedside lamp turns off between specific (and set) hours, central device monitoring server 304 will alert the control hub 352 that the resident has gone to sleep, and in response turn off the porch lights. In expansion of this concept, in various embodiments, any device within the home can be used as the trigger event for any other event within the home or other system. These events may not be limited to on/off triggers, but may instead be used to trigger notifications to the resident or any other manager.

Although in FIG. 13, control lines are shown as separate from the electrical power lines, in some embodiments, control signal may be sent over the electrical power lines (for example, using power line communications.) In some embodiments, signals are transmitted or received into an electrical system monitoring device (such as from electrical system monitoring device 306 to a power consumption monitor, control hub 352, a modem, or a router) by way of power line communications.

In some embodiments, a resident may be notified by a message provided on a computing device, such as a smart phone, tablet, or desktop computer. In some embodiments, the system provides notifications to a resident or home owner through one or more other mechanisms. For example, the system may provide notifications to a dedicated power monitoring control panel or by way of an audible message made over a loudspeaker system. In certain embodiments, the system provides a notification by operating electrical devices in a signaling manner. For example, if the downstairs lights in a home are on after a certain hour (for example, 1:00 am) and the system detects the upstairs bedroom lights going off, the system may flash the upstairs lights to provide the resident with a visual indication that there are other lights still on in the home.

In some embodiments, a system provides information and controls enabling a homeowner to use information about specific devices being monitored to control those specific devices. For example, the system may use electrical signature data to determine that a television set has is on, and use GPS data from owner device 362 to determine that the owner of the residence is in a remote location. The system may provide a notification to the owner at the remote location that the set television set has been left on. The system may also prompt the owner to shut off the television set which can be accomplished remotely by the users control system.

Is some embodiments, a home intelligence system performs disaggregation of electrical devices by capturing electrical signatures of specific devices in the residence. Specific devices identified may be grouped into two or more zones in the residence. Based on measurements of state of operation, usage and/or power consumption by the specific electrical devices, notifications relating to one or more of the specific devices may be determined and provided to the home owner. Disaggregation may include non-intrusive load monitoring.

For illustrative purposes, disaggregation, power consumption reporting, specific device and zone-related notifications, recommendations, and other functions of the home intelligence system shown in FIG. 13 are distributed among a local device and remote server. A home intelligence system may, however, perform all of its functions entirely locally at a residence (for example, in electrical system monitoring device 306), or entirely remote from a residence. Various functions of the system may be allocated in a manner other than that shown in FIG. 13. For example, signatures may be computed entirely locally, while notifications and recommendations may be determined remotely.

In some embodiments, a local signature capture device accesses data stored in locations other than a residence by way of a network, and uses the information to determine electrical signatures for one or more electrical devices in a residence. For example, the local device may access model signatures for off-the-shelf components, such as a particular model of television or dishwasher.

FIG. 14 illustrates disaggregation and device-specific notification according to one embodiment. In some embodiments, an initial disaggregation phase is carried out to develop electrical signatures that can be used for monitoring usage in the home and for providing notifications. In this example, at 400, characteristics of electrical power lines in a residence are measured. The characteristics may include, in some embodiments, current and voltage. Specific device identification may be made using combination of (a) user input and (b) a database of parameters that may be internal and/or external to the system.

In some embodiments, information generated using disaggregation is combined with smart meter data. Smart meter data may be integrated with data acquired from specific devices and used, for example, to show savings or correlate with overarching trends in energy usage.

At 402, information for device identification is received from a user (e.g., home owner) and from external sources. Information from a user may include an inventory of electrical devices on each circuit. For example, the home owner may provide a list for each circuit in the residence. The list for one circuit may include a list of kitchen appliances by manufacturer and model number, the list for another circuit may include a list of electrical devices used in a bedroom, and so on. This external source may also be determined via other methods such as a home assessment during installation.

External sources of information that can be provided to a system for use in device identification may include, for example, a database that has electrical signatures for a variety of electrical systems, such as electrical signatures for a particular make and model of a television system, a stove, or a refrigerator. These external sources of information can also be stored locally on the device used for measurement and device identification.

At 404, based on the measured electrical characteristics, an electrical signature for each of the electrical devices may be determined. In some embodiments, each electrical device is associated with an electrical device type (for example, Device 146 is a washer, Device 147 is a dryer, Device 148 is an iron, and so on.) In some embodiments, electrical signatures of specific devices are determined by disaggregation using, for example, a mathematical algorithm. Data processing such as a Fourier transform may be used to in order to move the data from the time domain to the frequency domain. Various other techniques used in the field of digital signal processing may be used to identify specific devices, such as high/low pass filters. Sampling of current and voltage may be carried out at a high frequency (for example, 10 KHz). In one embodiment, the sample frequency is more than twice the highest frequency of the sampled device's electrical signature.

Statistical analysis may be performed on data acquired relating to factors, including current voltage, and phase, time of day, day of week, to determine signatures for specific electrical devices in a residence.

In some embodiments, the system is unsupervised in that it seeks to detect unique patterns without any sort of database or human input. Internally, the system is responsible for extracting these patterns, identifying them in the future, and updating as the pattern drifts. An example of drift would be a refrigerator running slightly longer as the seal degrades.

In some embodiments, human intervention is sometimes used in interpreting the results. This may be presented to the user as a timestamp and real power (watts). The user can use these to correlate to real world event, like a device turning on, and identify it in the system.

At 406, some or all of the identified electrical devices are assigned to one or more zones. For example, kitchen appliances may be grouped into a Kitchen zone, home ac and heaters may be grouped into a heating and cooling zone, and so on.

Once initial disaggregation has been carried out throughout the residence, the system may have information of specific devices throughout the residence, including a list of specific devices with its associated zone and device type. The electrical signature for each specific device is maintained in association with identification information for the device. Disaggregation may continue to be carried out in real-time while the system is used to monitor and manage electrical devices in the residence.

At 408, electrical power may be measured to detect the state of the specific devices in the residence. The state may include whether the specific device is on or off, usage, and/or power consumption of the specific electrical devices. The electrical signatures for each of the electrical device may be used to assess operation of the specific device, including determining when a given device is turned on or turned off, what mode of operation it is in, how much power it is consuming.

Zone-by-zone power consumption information (including, for example, breakdown by zone, comparisons to past usage or power usage of specific individuals) may be reported to a person associated with the residence (for example, the owner of the residence) in real-time. The system may report specifically how much energy each of the residents used over a given period of time based on which devices they used, number of hours they were in the home or which areas of the house they spend the most time.

At 410, the system may receive information about conditions external to the electrical power system. For example, the system may receive weather data, information about the status of the owner, information about the status of systems in a neighboring residence.

At 412, device-specific notifications of events or conditions (e.g., improper setting by the user, abnormal usage, or a device left on, all current states of devices on, off, low, medium, high, device instantaneous power usage, device energy consumption over time period, usage trends of devices by time period) may be determined. The system may implement one or more learning algorithms to identify use by specific devices and assess patterns of use and operation for the specific devices.

Device-specific notifications may be based on combinations of information from the measurements of the electrical power system, external conditions, or combinations thereof. The notifications may include identification of the relevant zone. Such notification may help the user save money, provide additional convenience or improve the safety of the building and residence. An example of helping to save money would be a notification that tells the user which devices are consuming power even when the residents aren't home or using the device, such as a cable box. An example of providing additional convenience is alerting the resident when the laundry has completed so that the clothes don't wrinkle. An example of safety is reminding the resident that a curling iron has been left on for an extended period of time helping to prevent a potential fire hazard.

In some embodiments, a system provides a resident with abnormal use information for particular zones. A push notification may be provided to a resident, for example, if energy consumption in a particular zone is abnormally high or low. Also, the resident may be provided with information that a device has been misconfigured, lights have been left on, a stove has been left on, a timer has been set wrong. For example, the system may send a notification is a pool pump is running for 6 hours in the middle of the night.

In some embodiments, a system uses learning algorithms based on frequency of use, abnormal energy consumption or other criteria. The system may provide a notification based on changes in a pattern of use of device being monitored. If the frequency of actual use of a specific device in a residence does not match a pattern established by previous use recorded by the system, the system may provide a notification based on the change in use.

In some embodiments, the system may account for electrical usage of sub-components of a an electrical system. For example, a system may include electrical signatures that whether particular burners of a stove are on, or whether an electric oven is on, or both simultaneously. In some embodiments, a system distinguishes between different modes of operation of system. For example, the system may distinguish between a ceiling fan operating at a high speed or the same ceiling fan operating at a low speed.

In one embodiment, the system breaks usage down into three categories: variable energy usage, base energy usage, and HVAC usage.

At 414, notifications of event or conditions may be provided to a person associated with the residence (for example, a resident or home owner). In some embodiments, the notification is provided to an owner of the residence. The notifications may by way of a remote device, such as a smartphone. Notifications may be made in real-time.

In some embodiments, using the electrical signatures and the measured of power consumption by specific electrical devices, the system detects or predicts adverse events or conditions associated with the devices (for example, the device is about to fail, the device is wasting energy, or there is a breach of security or safety such as an open garage door or curling iron left on). Device-specific notifications (for example, alerts, warnings) relating to the actual or predicted adverse events or conditions can be provided to an owner using the device-specific electrical signatures.

Examples of notifications that may be provided include actual events or conditions that have occurred, or events and conditions that are at increased likelihood of occurrence. For example, based on patterns of electrical usage, the system may provide a notification that particular appliance or system is likely to fail within a given time period, or is about to fail. In some embodiments, the system provides a notification that usage of a specific device is abnormal. In some embodiments, the system provides a notification that a particular device is consuming an excess amount of energy. In some embodiments, a system provides notifications of how much a customer has spent for a particular device in a given period. The may amount spent information may be provided for custom set intervals. Also, the system may provide a notification if a customer is about to enter a new pricing tier.

In one embodiment, the system provides a user with comparisons power consumption or performance of a specific device relative to similar devices in other residences.

Notifications may be delivered by way of computer display, alarm, or other device. In certain embodiments, a notification is provided by controlling one or more electrical devices in the residence in a pre-defined manner that serves as a warning the occupant. For example, if a problem exists, the system may flicker lights on and off to warn the user of the problem.

In some embodiments, notifications are based on historical data for a specific device that has been acquired by the system. For example, changes in the electrical signature of a device may be used to determine that a particular device is about to fail. In one embodiment, a notification predicting failure of a specific device is based on a combination of historical information for the specific device and weather data.

In some cases, the system uses a combination of external conditions (such as weather data, location data for the owner) and historical patterns previously acquired by the system for a specific device. In some cases, the system implements layered triggers that rely on a combination of two or more factors (for example, time of day+anomalous device usage+owner location). In some embodiments, the system uses the state (on/off, medium, high, low) of many devices in the residence to provide a combination of “if” statements (for example, three or more “if” statements) to automatically determine a notification. As an example, a notification may be sent if the refrigerator door is left open, and if the lights are off in the kitchen and if the TV is off: then flicker the lights on/off.

In some cases, the system uses information about an owner or resident in combination with information about the status of a particular electrical device to determine a notification.

At 416, recommendations are provided to a person associated with the residence. In some embodiments, the system detects the different devices that are on in a residence and how frequently they are used. Based on this usage information, the system may determine suggestions or recommendations. For example, if the resident using his or her oven more often than other people, the system may determine that the resident likes to bake and present advertisements for baking accessories. As another example, if the system detects that the resident has the newest video game consoles and that they are played often, then the system may deliver advertising to the user for a new video game.

In some cases, the system provides recommendations for action that a resident can take relating to an electrical device being monitored (for example, to a recommendation to take an action that would improve energy efficiency). The recommendations may be tailored to a particular user or residence based on measurements of the specific devices in the residence. For example, based on computation performed using data about specific device usage, the system may provide a recommendation to turn up the air conditions two degrees, or to replace insulation.

In some embodiments, the system makes projections on the effect a change in operation of one or more devices in a residence. In some cases, the projections relate to the effect of implementing a recommendation. For example, the system may project to a user that if the thermostat were turned up three degrees (which may be a recommendation), the savings would be $75.

The system also make projections about the effects of adverse conditions or effects. For example, the system may project that energy consumption costs will increase by $8 per month if the air filter of the air conditioning system is not changed.

In some cases, the system provides recommendations for corrective action and/or for replacement or repair of specific devices. Using the electrical signatures and the measurement of power consumption by specific electrical devices, the system detects or predicts failure, malfunctions, or degrading performance of specific electrical devices in the building. The system can combine this information with information about options and sources for purchasing replacement systems/components, repair services, including promotions, sales, or rebates, and present options the owner.

In some embodiments, failure of a system is predicted using a combination of historical data for particular device is correlation with weather data. For example, the system may establish a baseline for how much energy a particular device as a function of outside temperature and humidity. If the actual usage deviates from the baseline, the system may determine that the device that one or more components of the system are breaking down and that the system is more likely to fail.

In some embodiments, a person associated with the residence (e.g., owner of the residence) control electrical devices in the residence based on notifications received from the system. In some embodiments, a system includes controls (e.g., remote power switches) that allow the owner to control the specific electrical devices (turn devices on and off, adjust thermostat) based on the notifications and/or recommendations.

In certain embodiments, a system may use electrical signatures to keep track of a location of an electrical device within a building. The system may keep track of an electrical device being shifted from one zone to another. In some embodiments, the system keeps track of usage of the device in the different zones using the electrical signature determined for the device. For example, the system may determine that a notebook computer is in the kitchen 40% of the time, and in the living room 60% of the time. As another example, in an industrial setting, a system may use electrical signatures to determine that a portable welding machine is used 30% of the time in one shop, and 70% in another shop.

In some embodiments, electrical signatures are acquired in an initial electrical signature determination for specific electrical devices in the residence. In certain embodiments, the system may use these initial electrical signatures for power usage reporting, notifications, and recommendations such as those described herein. The system may nonetheless continue to acquire additional information, and update, refresh, or re-compute electrical signatures (e.g., on a continuous, periodic, or on-demand basis). In some embodiments, electrical signatures for some or all of the specific devices are determined and implemented in real time.

In various embodiments, notifications are made to persons other than a resident. For example, a notification may be made a security company system that an abnormal condition exists, such as a garage door being open when the user is away.

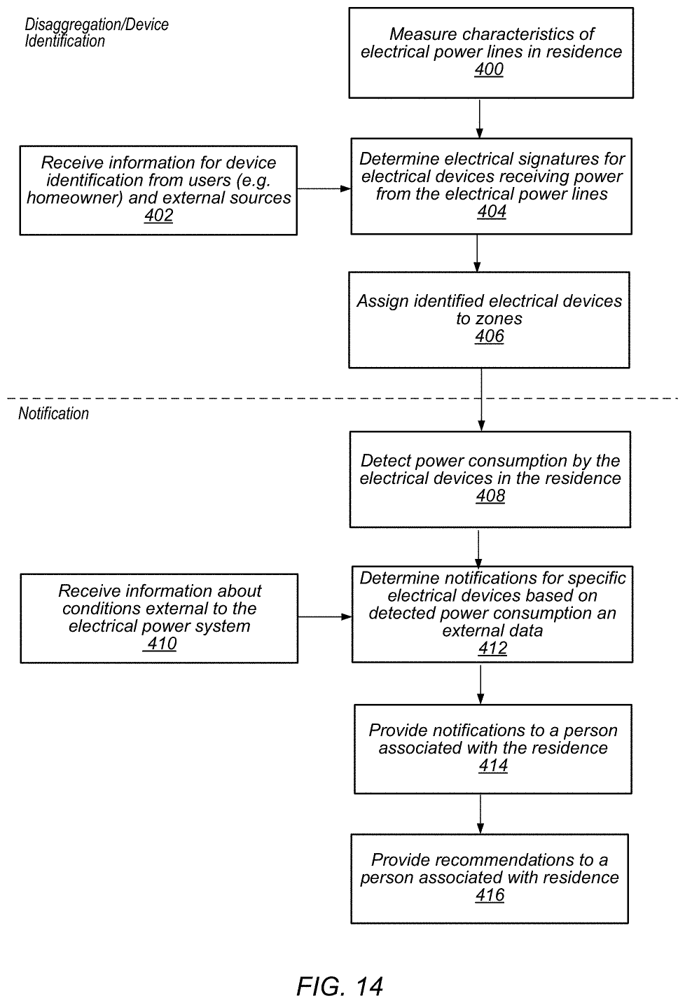

FIG. 15A illustrates one embodiment of a signal produced by measuring electrical power lines supplying power to an air conditioner. The graph shows amplitude versus time. FIG. 15B illustrates a transformation of the signal for the air conditioner into a frequency domain. The graph shows amplitude versus frequency. The characteristics of the signal in the frequency domain may be used by the system to produce an electrical signature for the air conditioner.

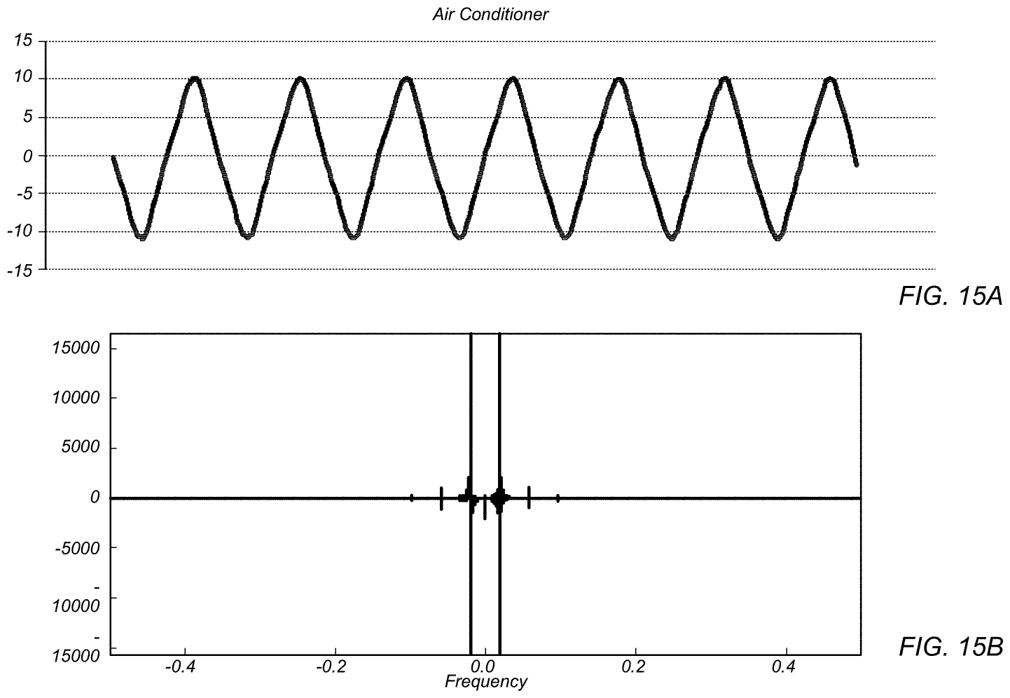

FIG. 16A illustrates one embodiment of a signal produced by measuring electrical power lines supplying power to a 32 inch LCD television. The graph shows amplitude versus time. FIG. 16B illustrates a transformation of the signal for the 32 inch LCD television into a frequency domain. The graph shows amplitude versus frequency. The characteristics of the signal in the frequency domain may be used by the system to produce an electrical signature for the 32 inch LCD television. In this case, the frequency characteristics can be used to by the system to distinguish operation of one electrical device in a residence versus another.

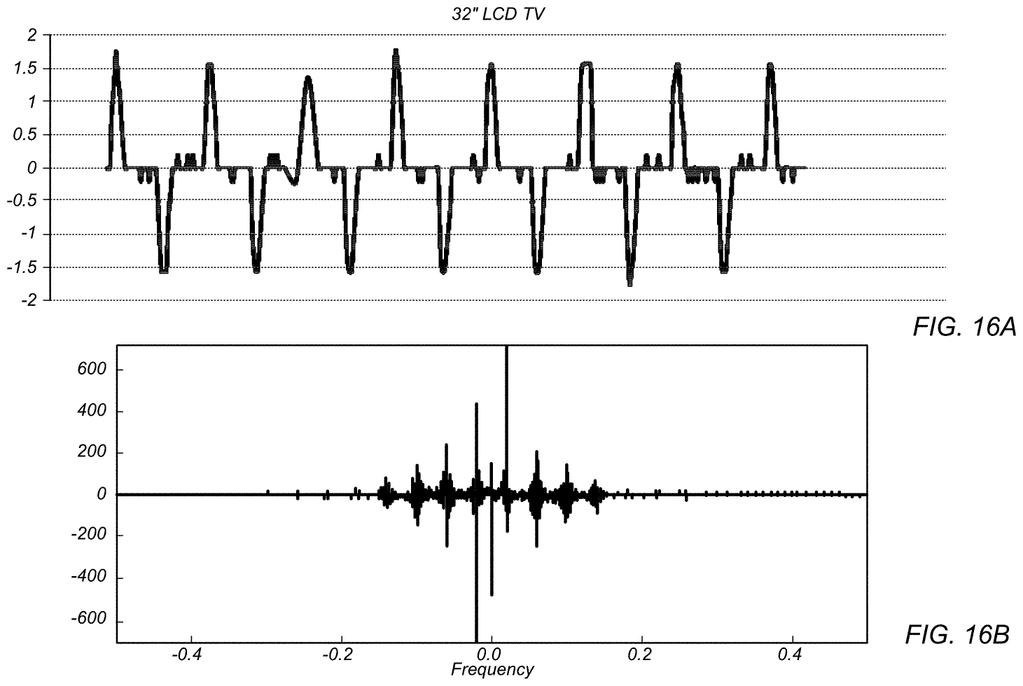

In some embodiments, the system keeps track of when any of various identified electrical devices are on or off. FIG. 17 is a graph illustrating on/off tracking of several electrical devices in a residence. In this case, the graph represents switching of electrical devices in a kitchen over the course of a month. The y axis is the power draw that device uses. Each dot represents the transition of a device, either turning on or off, where the hatching represents the grouping of devices. The on and off transition for a given device may be represented as two separate patterns. In some embodiments, a user may be presented with a graph in which each device is represented by a different color. On and off transition for a given device is represented by two different colors.

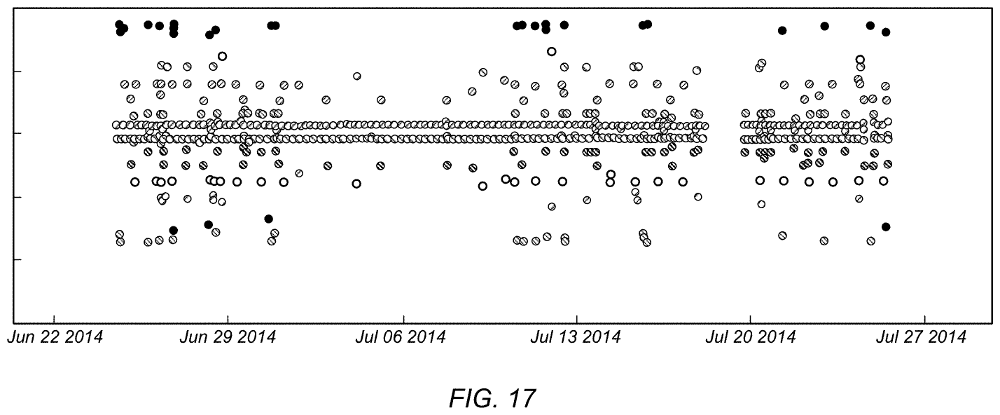

FIG. 18 illustrates one embodiment of a display for providing information about usage of electrical devices in a residence to a home owner, by device and zone.

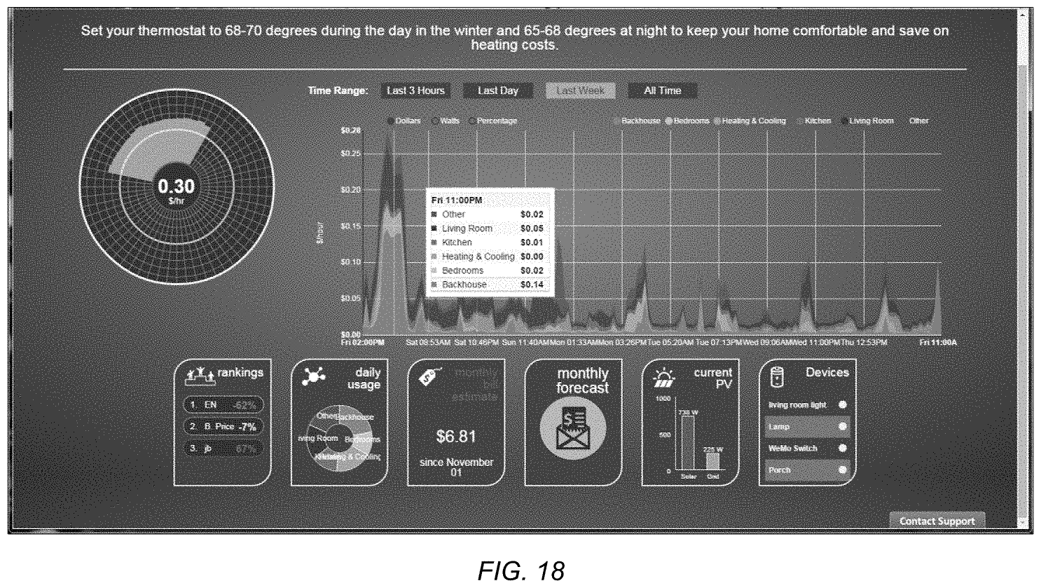

FIG. 19 illustrates one embodiment of a display for providing information about usage of electrical devices in a residence to a home owner, with a breakdown by zone, room, or display.

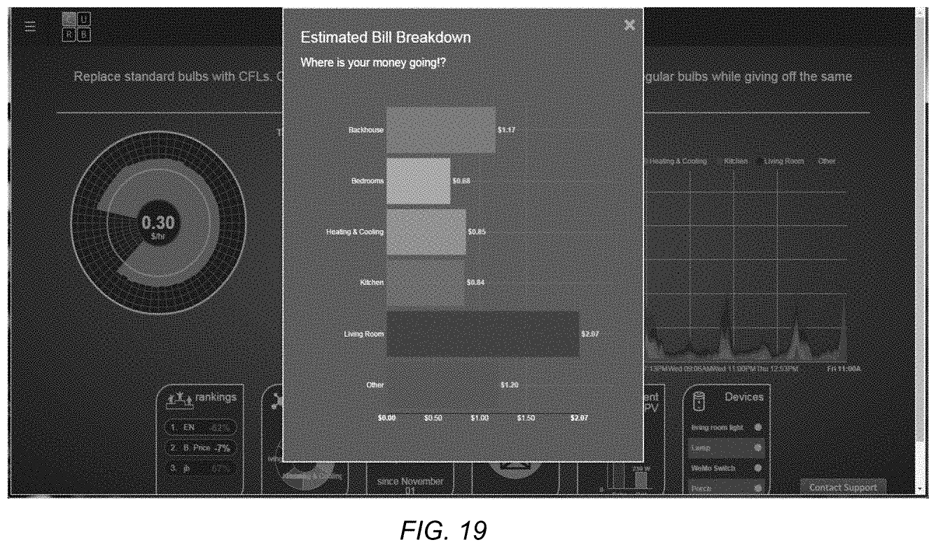

FIG. 20 illustrates one embodiment of a display for providing information about usage of electrical devices in a residence to a home owner, with forecasted usage by room, appliance, and zone.

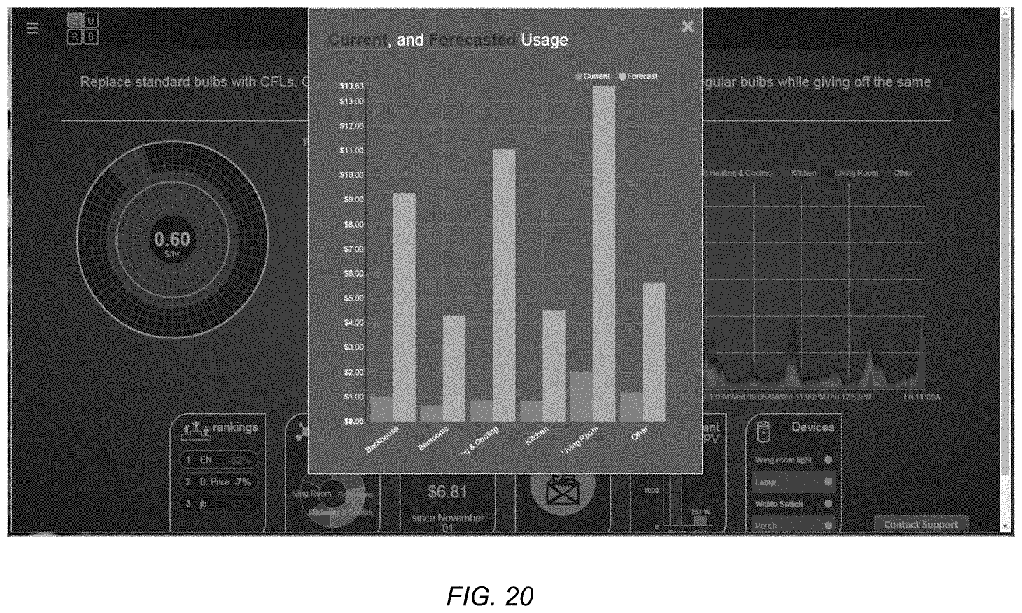

FIG. 21 illustrates one embodiment of a display for providing information about usage of electrical devices in a residence to a home owner, with a three-hour consumption window and identification by zone and appliance.

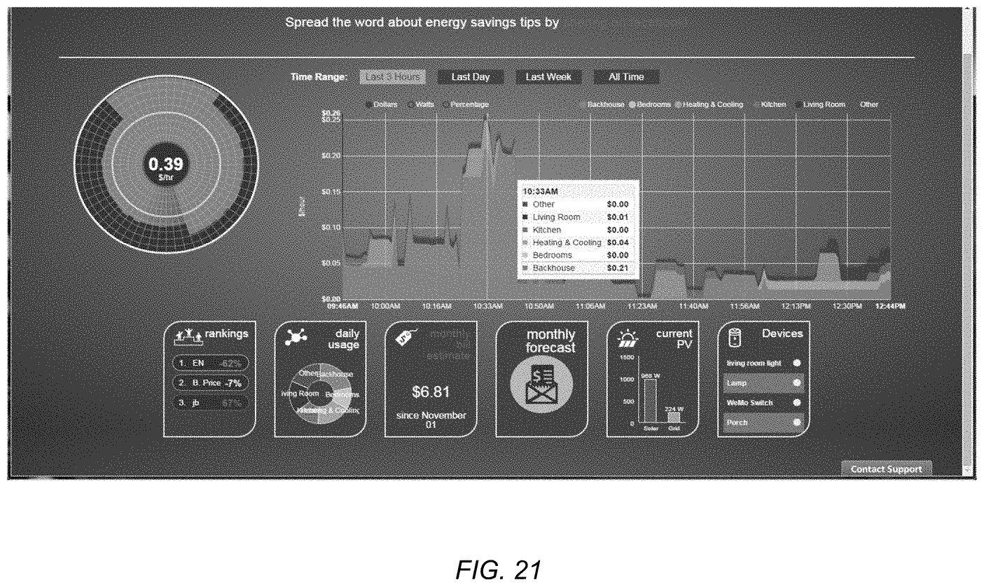

FIG. 22 illustrates one embodiment of a display of a tutorial for a homeowner about usage of electrical devices in a residence. The tutorial guides the homeowner to use the display options to evaluate the effects of using various devices on total energy consumption.

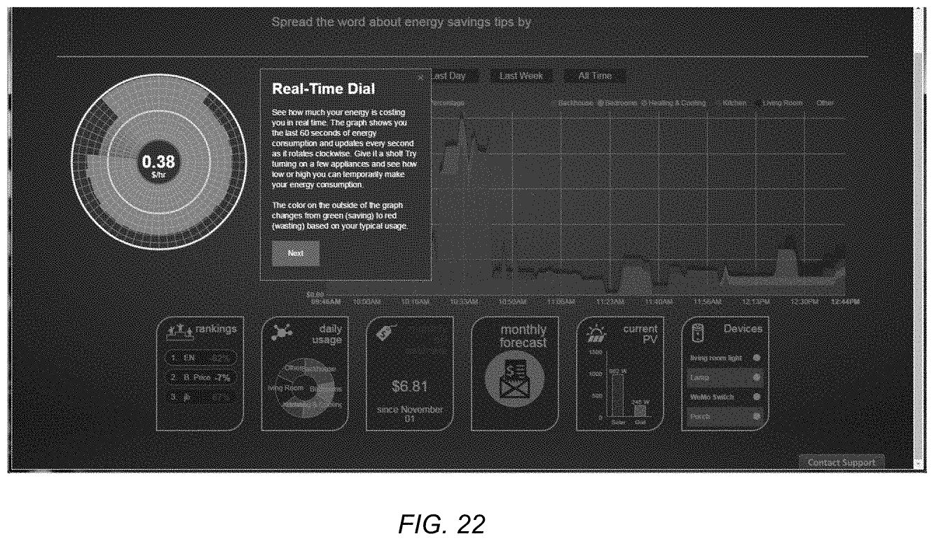

FIG. 23 illustrates one embodiment of a display with a graph showing a comparison of different usage to their typical energy consumption and to each other.

In some embodiments, a signature capture device is installed at a residence or other building to collect information for an electrical power system for use in disaggregation, monitoring, and control of electrical devices in the building. The signature capture device may be coupled to the electrical power lines for various circuits in a home (for example, the power conductors for various circuits in a breaker box). In one embodiment, a signature capture device includes an analog-to-digital converter, a microcontroller and a processor.

A processor of signature capture device may perform transformations (e.g., Fourier transforms and other digital signal processing) and computations of the data received for each circuit. Information that may be used in determining a signature includes voltage, current, and watts, frequency, amplitude, phase angle, power factor.

In some embodiments, information acquired or computed in a local device is sent to the cloud. Devices in the cloud may determine electrical signatures based on the information received, notifications, recommendations, and power consumption information to be provided to residents. In the cloud, information received from the signature capture device may be combined with other information such as power factor, phase angle, weather, time of day, or day of week, to determine electrical signatures for the devices in the various zones in the home.

In some embodiment, a signature capture device provides outputs to send control signals or data over power lines (e.g., using data over power line communications) to the monitored devices. For example, a signal may be sent from the signature capture device to control device coupled to an air conditioning unit or dryer in order to control the on/off state of the device.

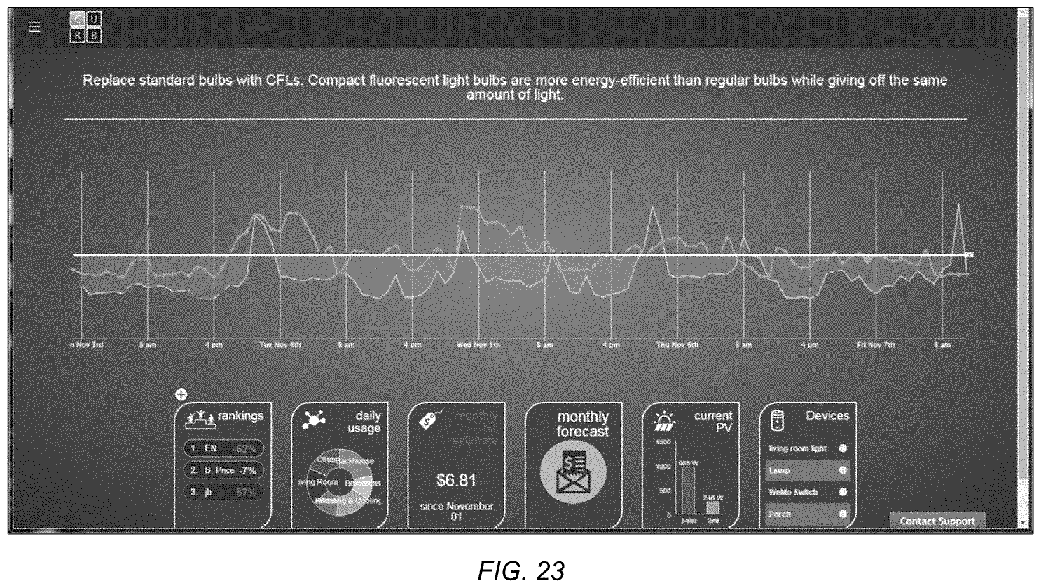

FIG. 24 illustrates one embodiment of a signature capture device installed at the breaker box of a residence. In this embodiment, the signature capture device may couple to conductors in the breaker box to sense voltage and current.
a) Voltage—Voltage may be measured by a direct connection into the 2 (residential) or 3 (commercial) different voltage phases and allows the signature capture device to measure the voltage, phase angle and power factor. The voltage input also powers the signature capture device (converts to DC current) as well as enables the signature capture device to communicate back to our cloud server—through PLC (power line communication).
b) Current—Current may be measured by placing current sensors around any or all of the wires for which current is to be measured. Any of a variety of types and sizes of current sensors may be used to accomplish this. The sensors may be passive. Examples of current sensors that may be used are: 1) Current Transformers, which contain a solid magnetic, and 2) Rogowski coils, which do not contain magnets. Passive sensors may allow for faster and easier installation.

Signature capture system 500 includes signature capture device 502, current sensor array 504, AC/DC power module 506, and power line communication module 508. Current sensor array 504 includes current sensors 510. Current sensors 510 are coupled at desired locations on the conductors for various circuits in breaker box 512. Current sensors 510 may be in the form of current measurement clamps. Current sensors 510 are electrically connected to signature capture device 502 by wires in current sensor array. The signature capture system 500 may also include connections for sensing voltage in each circuit.

AC/DC power module 506 may couple with one or more conductors in breaker box 512. AC/DC power module 506 may use power from the home to supply electrical power to operate components of signature capture device 502.

Power line communication module 508 may be used to transfer information between signature capture device 502 and external systems. Power line communication module 508 may, for example, enable exchange of information between signature capture device 502 and a remote home intelligence system or a local home intelligence server. Additionally, all other wireless and wired forms of communication may be used to transmit this data.

In certain embodiments, power line communication module 508 enables the signature capture system 500 transmits and receives signals to and from electrical devices in the home. The signals may be used to monitor or control the electrical devices. For example, various lights or appliances in a home may be outfitted with PLC-enabled switches. In response to a notification or a command from a home owner, signature capture device 502 may switch such devices on or off.

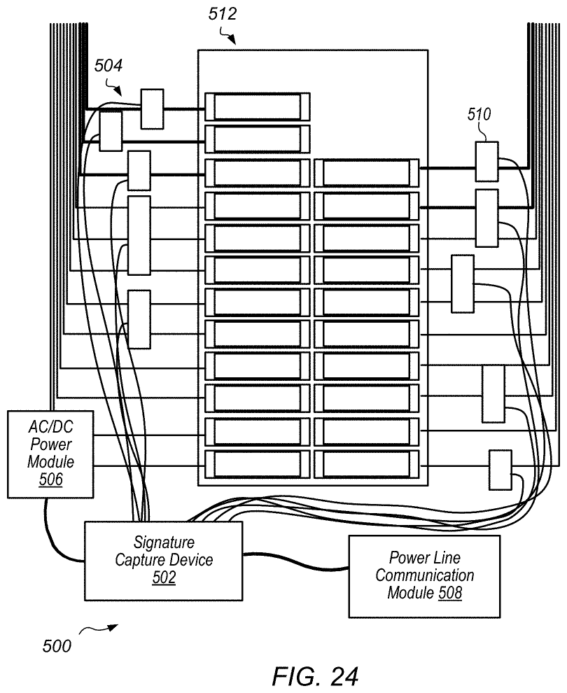

FIG. 25 illustrates one embodiment of input/output for a signature capture system. Signature capture device 520 may be coupled to power lines 521 (hot conductors, phases A and B) by way of voltage input connectors 524. In one embodiment, the device includes conductors for receiving signal for up to 18 zones. Signature capture device 520 may be coupled to conductors in circuit breaker box 522 by way of current input connectors 526. Signals and data may be exchanged via Ethernet connection 528, power line communication module 532, or any other wireless process (such as Z-wave, ZigBee, WiFi, BlueTooth, Bluetooth low energy, cellular, etc). AC/DC power module 530 may supply power from the home to components on signature capture device 520. In this example, the system I/O is for two-phase AC. In some embodiments, however, a system may couple with three-phase power, single-phase power, or other types of power.

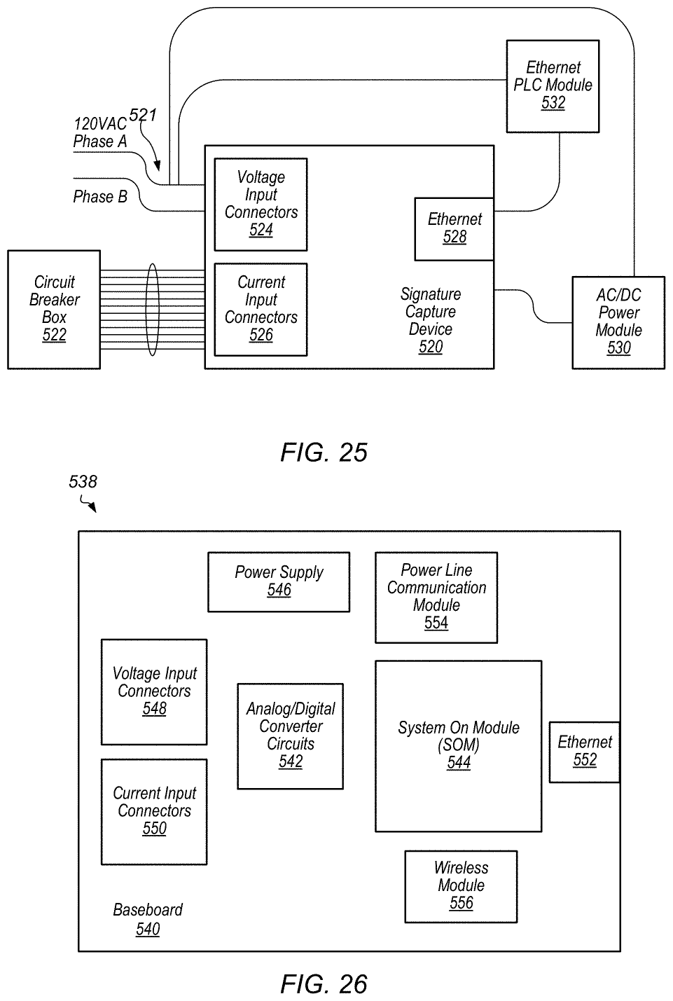

FIG. 26 illustrates one embodiment of an embedded controller board for a signature capture device. Signature capture module 538 includes baseboard 540, analog/digital converter circuits 542, system on module (SOM) 544, and power supply 546. The SOM 544 may include one or more CPUs. Instructions may be provided to the CPU for performing signal processing of signals received from electrical power lines. Analog/digital converter circuits 542 may receive input from electrical power lines in a building by way of voltage input connectors 548 and current input connectors 550. Power supply 546 may supply power to components on baseboard 540.

System on module (SOM) 544 may process digital signals converted from analog signals by analog/digital converter circuits 542. Signals and data may be exchanged with external devices and systems by way of Ethernet connection 552, power line communication module 554, or both. In certain embodiments, signals and data are exchanged by way of wireless module 556. The wireless module may be, for example, ISM band or WiFi.

In some embodiment, a system acquires electrical signatures for devices by measuring characteristics of electrical power lines supplying power to the devices in a facility or building (which may be commercial, industrial, or residential). Using the electrical signatures and the measured of power consumption by specific electrical devices (including historical information for the devices in the facility or building) the system provides information on the actual or predicted contributions of various devices to peak power consumption (either peak power consumption by the entity itself or peak power consumption associated with a utility provider (e.g., peak demand as described below)). The information can be used to reduce peak power, which in turn may reduce utility rates for the facility or building.

In some embodiments, the system detects all of the different devices that are used in a commercial setting and performs an optimization to operation of the factory or business (e.g., the entity) to reduce peak consumption. For example, by offsetting the timing of manufacturing lines and heating processes, an entity (e.g., a manufacturer) may reduce its peak demand. More broadly, if there are numerous different devices that are used throughout a day, the system may produce an optimum profile, with a time of operation for each of the devices, to reduce the peak demand consumption. The optimum profile may include, for example, usage for various devices that offsets usage of other devices, usage for devices that offsets peak usage by other entities, or usage for devices that offsets peak demand on the utility provider.

In some embodiments, the profile may take into account peak demand times for the utility provider supplying electricity to the entity (e.g., peak power consumption is the peak of consumption by the utility provider). In such embodiments, the produced profile may suggest usage that avoids large usage by the entity during the peak demand times for the utility. For instance, the produced profile may suggest higher usage during low demand times and reduced usage during peak demand times for the utility. The produced profile may take into account predicted contributions by the entity (and individual devices within the entity) to consumption during the peak demand times for the utility.

In certain embodiments, the produced profile may include “pre-cooling” or “pre-heating” before peak demand times begin. For example, with pre-cooling, a residence or building (or a portion of a residence/building in use) may be cooled to a temperature below the desired temperature before the peak demand time begins. Thus, while the temperature may rise during the peak demand time, any cooling provide during the peak demand time does not include bringing the temperature down from a higher temperature but maintenance of the desired temperature, which is less costly in energy consumption.

In various embodiments, multiple entities being supplied by a utility may have suggested profiles. Accordingly, the utility (or an entity controlling resources for the utility) may be able to control (or suggest control) to adjust individual energy usage by the entities in order to balance the load for the utility. Balancing the load for the utility may allow the utility to continue reasonable operation of supplying the entities without the need for additional power plants or obtaining additional power from another provider.

### Cloud Computing System

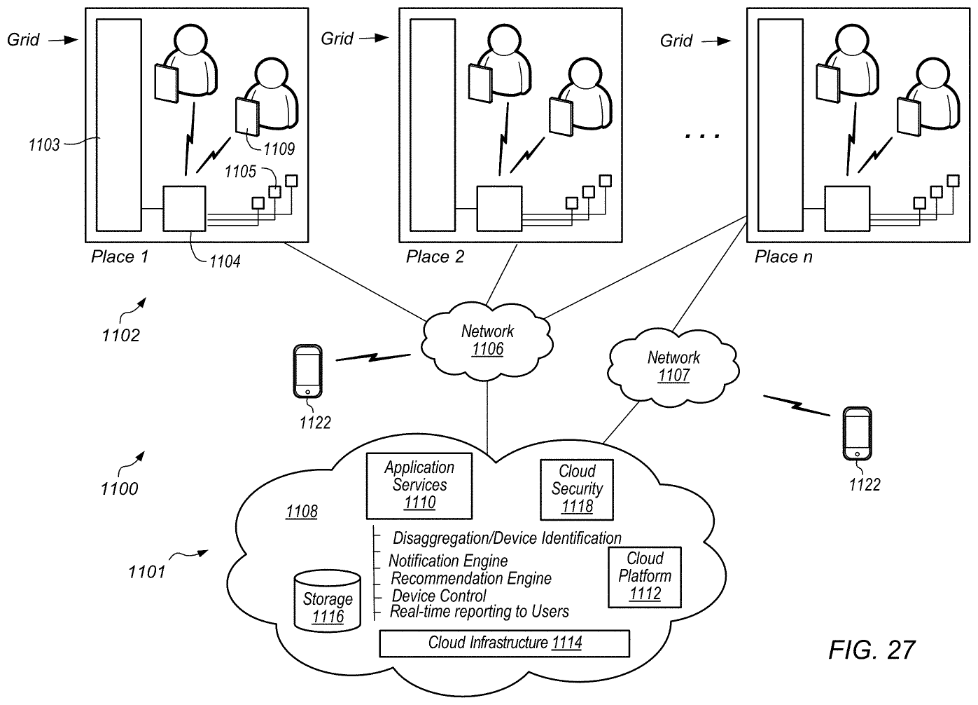

In some embodiments, the system for providing intelligence to home owners or other building occupants are provided by way of a cloud computing system over a communications network. FIG. 27 illustrates one embodiment of a cloud computing system that can be implemented to carry out resource consumption monitoring and reporting, building intelligence, device disaggregation, notifications, recommendations, and control. System 1100 includes building intelligence system 1101 that provides device power consumption monitoring, disaggregation, notification, power consumption management and reporting for buildings 1102. Each of places 1102 includes load center 1103, data gathering and reporting server 1104, and building sensors 1105. Load center 1103 receives power from grid for various energy consuming systems and devices at place 1102. Each load center 1103 may include one or more signature capture devices, similar to those described above relative to FIGS. 13 and 24-26. Some or all of the individual occupants at place 1102 may be able to view information on occupant display devices 1109.

Each of places 1102 may be connected to cloud computing system 1108 by way of network 1107. In certain embodiments, occupant display devices 1109 are connected to one another by way of network 1106.

Cloud computing system 1108 may provide remote computing resources, remote storage resources, or both, for systems connected to cloud computing systems 1108. For example, cloud computing system 1108 may provide cloud computing services to users at places 1102. Occupant display devices 1109 may be, for example, workstations or mobile devices.

Various system architectures may be employed in cloud computing system 1108. Systems and components of cloud computing system 1108 may be at a single physical location, such as a data center, or distributed among any number of locations. Cloud computing system 1108 includes cloud application services 1110, cloud platform 1112, cloud infrastructure 1114, cloud data storage 1116, and cloud security 1118. Cloud applications services may be implemented by way of one or more computer systems, each include one or more central processing units, such as described herein. Examples of application services 1110 include providing power consumption monitoring, disaggregation, notification engine, recommendation engine, device control, optimization, game management, and reporting. Cloud application services 1110 may access cloud data storage 1116.

Cloud infrastructure 1114 may encompass a variety of physical resources, such as computing devices, servers, block storage, mass storage devices, file servers, software, and network systems. In some embodiments, a cloud computing system encompasses virtualized resources, such as virtualized data storage or virtualized hardware.

In some embodiments, a service provider provides services to occupants of places 1102 by way of cloud computing resources. In some embodiments, computation resources are rented or leased to customers of the service provider. In certain embodiments, services are provided to users at sites as software as a service (“SaaS”) or platform as a service (“Paas”). Services may be provided to each user on an on-demand basis.

Networks 1106 and 1107 may include any suitable data network or combination of networks that enable the exchange of information between electronic systems. For example, networks 1106 may include one or more Local Area Networks (LANs) such as Ethernet networks, as well as Wide Area Networks (WANs), Metropolitan Area Networks (MANs), or other data or telecommunication networks implemented over any suitable medium, such as electrical or optical cable, or via any suitable wireless standard such as IEEE 802.11 (“Wi-Fi”), IEEE 802.16 (“WiMax”), etc. In various embodiments, all or a portion of networks 1106 may include the network infrastructure commonly referred to as the Internet. In other embodiments, networks 1106 and 1107 may be entirely contained within an enterprise and not directly accessible from the Internet. In certain embodiments, information may be exchanged over a virtual private network. In one embodiment, information is exchanged over the internet, but encrypted in such a way to make a private network not accessible from the rest of the internet.

In various embodiments, some users may be connected over a different network than other users. For example, as shown in FIG. 27, users may be connected to cloud computing system 1108 over network 1107. In some embodiments, one or more users are connected over a private network. For example, in the embodiment shown in FIG. 27, network 1106 may be a public network and network 1107 may be a private network.

In various embodiments, a user may communicate over systems in system 1100 from locations external to users and cloud computing system 1108. For example, a decision maker may communicate with users at a remote location by way of portable electronic devices 1122. Portable electronic devices 1122 may be located anywhere, including at places 1102 or a remote location.

Although for illustrative purposes only three places are shown in FIG. 27, a system may include monitoring and reporting for number of places and any number of computer systems.

Computer systems may, in various embodiments, include components such as a CPU with an associated memory medium such as Compact Disc Read-Only Memory (CD-ROM). The memory medium may store program instructions for computer programs. The program instructions may be executable by the CPU. Computer systems may further include a display device such as monitor, an alphanumeric input device such as keyboard, and a directional input device such as mouse. Computer systems may be operable to execute the computer programs to implement computer-implemented systems and methods. A computer system may allow access to users by way of any browser or operating system.

Computer systems may include a memory medium on which computer programs according to various embodiments may be stored. The term “memory medium” is intended to include an installation medium, e.g., Compact Disc Read Only Memories (CD-ROMs), a computer system memory such as Dynamic Random Access Memory (DRAM), Static Random Access Memory (SRAM), Extended Data Out Random Access Memory (EDO RAM), Double Data Rate Random Access Memory (DDR RAM), Rambus Random Access Memory (RAM), etc., or a non-volatile memory such as a magnetic media, e.g., a hard drive or optical storage. The memory medium may also include other types of memory or combinations thereof. In addition, the memory medium may be located in a first computer, which executes the programs or may be located in a second different computer, which connects to the first computer over a network. In the latter instance, the second computer may provide the program instructions to the first computer for execution. A computer system may take various forms such as a personal computer system, mainframe computer system, workstation, network appliance, Internet appliance, personal digital assistant (“PDA”), television system or other device. In general, the term “computer system” may refer to any device having a processor that executes instructions from a memory medium.

The memory medium may store a software program or programs operable to implement embodiments as described herein. The software program(s) may be implemented in various ways, including, but not limited to, procedure-based techniques, component-based techniques, and/or object-oriented techniques, among others. For example, the software programs may be implemented using ActiveX controls, C++ objects, JavaBeans, Microsoft Foundation Classes (MFC), browser-based applications (e.g., Java applets), traditional programs, or other technologies or methodologies, as desired. A CPU executing code and data from the memory medium may include a means for creating and executing the software program or programs according to the embodiments described herein.

Although various embodiments herein include a system that provides disaggregation, notifications, monitoring, and recommendations for a residence, disaggregation/notification systems such as described herein may be used for any place, including a set of office buildings, a factory, a school, a sports venue, or a hospital.

Some embodiments are set forth in the following clauses:

H1. A system for providing information about electrical devices in a residence, comprising:
a power measurement device configured to:
   measure one or more characteristics of electrical power in one or more electrical power lines in the residence;
an electrical device identification component configured to:
   determine, based at least in part on at least one of the measured electrical characteristics, electrical signatures for each of at least two of a plurality of electrical devices at the residence that are receiving electrical power through the electrical power lines;
   associate, based at least in part on at least one of the electrical signatures, one or more of the electrical devices with a device type; and
   group two or more of the electrical devices into two or more zones of the residence; and
a notification component configured to:
   determine, based at least in part on power consumption by the at least one specific electrical device detected by the power measurement device, an event or condition associated with the at least one specific electrical device, wherein the power consumption is detected using the electrical signature for the at least one specific electrical device; and
   provide, to a person associated with the residence, one or more notifications relating to at least one of the events or conditions associated with the at least one specific electrical device.
      H2. A method of providing information about electrical devices in a residence, comprising:
measuring one or more characteristics of electrical power lines in the residence;
determining, based at least in part on the measured electrical characteristics, electrical signatures for each of at least two of a plurality of electrical devices at the residence that are receiving electrical power from the electrical power lines;
associating, based at least in part on at least one of the electrical signatures, one or more of the electrical devices with a device type;
grouping two or more of the electrical devices into zones of the residence;
detecting power consumption by at least one specific one of the electrical devices, wherein the power consumption by the specific electrical device is detected by using the electrical signature for the at least one specific electrical device;
determining, based at least in part on the power consumption detected by the at least one specific electrical device, an event or condition associated with the at least one specific electrical device; and
providing, to a person associated with the residence, one or more notifications relating to at least one of the events or conditions associated with the at least one specific electrical device.
   H3. The method of clause H2, wherein determining the electrical signatures comprises disaggregation of two or more devices in at least one circuit in the home.
   H4. The method of clause H2, wherein the zones correspond to one or more rooms of the residence.
   H5. The method of clause H2, wherein the zones correspond to one or more functional areas of the residence.
   H6. The method of clause H2, wherein the zones correspond to one or more circuits of an electrical power distribution system in the residence.
   H7. The method of clause H2, wherein determining the electrical signatures is performed substantially continuously, the method further comprising providing one or more updates about one or more devices in the residence based on changes over time to one or more of the electrical signatures.
   H8. The method of clause H2, wherein determining at least one of the electrical signatures comprises transforming signal information from a time domain to a frequency domain.
   H9. The method of clause H2, wherein, for at least one of the electrical devices, the frequency of sampling is at least about twice the frequency of the electrical device signature.
   H10. The method of clause H2, wherein measuring the one or more characteristics of electrical power lines in the residence comprises measuring current in one or more of the electrical power lines.
   H11. The method of clause H2, wherein measuring the one or more characteristics of electrical power lines in the residence comprises measuring voltage in one or more of the electrical power lines.
   H12. The method of clause H2, further comprising providing one or more reports to a person associated with the residence, wherein the reports comprise real-time information about use of one or more of the electrical devices measured in the residence.
   H13. The method of clause H2, further comprising tracking an on/off state of one or more of the electrical devices.
   H14. The method of clause H2, further comprising reporting power consumption of one or more of the disaggregated devices at the residence.
   H15. The method of clause H2, wherein the notification relating to at least one of the events or conditions is of an actual adverse event or condition of one of the electrical devices in the residence.
   H16. The method of clause H2, wherein the notification relates to at least one of the events or conditions is of abnormal usage of at least one of the specific electrical devices.
   H17. The method of clause H2, wherein the notification relating to at least one of the events or conditions comprises notice of an increased likelihood of failure of at least one of the specific electrical devices.
   H18. The method of clause H2, wherein the notification relating to at least one of the events or conditions is of higher energy cost for at least one of the electrical devices.
   H19. The method of clause H2, wherein the notification relating to at least one of the events or conditions comprises a prediction of one or more adverse events.
   H20. The method of clause H2, wherein the notification relating to at least one of the events or conditions comprises a prediction of one or more adverse events, wherein the prediction is based on past usage information measured for the electrical device.
   H21. The method of clause H2, wherein the notification relating to at least one of the events or conditions is based at least on one or more historical patterns for at least one of the electrical devices.
   H22. The method of clause H2, wherein the notification relating to at least one of the events or conditions is based at least on one or more historical patterns relating to at least one of the electrical devices and on weather data.
   H23. The method of clause H2, wherein the notification relating to at least one of the events or conditions is based at least on one or more measurements of the electrical device and one or more conditions external to the device.
   H24. The method of clause H2, further comprising making one or more recommendations about one of the electrical devices based in part on measurements taken for the specific electrical device.
   H25. The method of clause H2, further comprising making one or more recommendations about one of the electrical devices based in part on measurements taken for the specific electrical device, wherein the one or more recommendations includes a repair option and a replace option.
   H26. The method of clause H2, further comprising making one or more purchase recommendations relating to at least one of the electrical devices, wherein the recommendation is based in part on measurements taken for the specific electrical device.
   H27. The method of clause H2, further comprising controlling one or more of the electrical devices based on at least one of the notifications.
   H28. The method of clause H2, further comprising controlling one or more of the electrical devices from a remote location based on at least one of the notifications.
   H29. The method of clause H2, further comprising displaying information about one or more electrical devices in the residence on a mobile device.
   H30. The method of clause H2, further comprising providing one or more notifications to a person associated with a residence, wherein the notification is based on smart meter data from the residence and analysis of one or more of specific electrical devices.
   I1. A method of providing information about electrical devices in a residence, comprising:
measuring one or more characteristics of electrical power lines in the residence;
determining, based at least in part on the measured electrical characteristics, electrical signatures for each of at least two of a plurality of electrical devices at the residence that are receiving electrical power from the electrical power lines;
detecting a state or usage level of at least one specific one of the electrical devices, wherein the state or usage level of by the specific electrical device is detected by using the electrical signature for the at least one specific electrical device;
determining, based at least in part on the state or usage level detected by the at least one specific electrical device, an event or condition associated with the at least one specific electrical device; and
providing, to a person associated with the residence, one or more notifications relating to at least one of the events or conditions associated with the at least one specific electrical device.
   I2. The method of clause I1, wherein at least one of the events or conditions is determined based on the state of two or more of the electrical devices.
   I3. The method of clause I1, wherein the notification is based on information about use of two or more electrical devices monitored using electrical signatures.
   I4. The method of clause I1, wherein determining the electrical signatures comprises disaggregation of two or more devices in at least one circuit in the home.
   I5. The method of clause I1, wherein the zones correspond to one or more rooms of the residence.
   I6. The method of clause I1, wherein determining the electrical signatures comprises disaggregation of two or more devices in at least one circuit in the home.
   I7. The method of clause I1, wherein the zones correspond to one or more rooms of the residence.
   I8. The method of clause I1, wherein the zones correspond to one or more functional areas of the residence.
   I9. The method of clause I1, wherein the zones correspond to one or more circuits of an electrical power distribution system in the residence.
   I10. The method of clause I1, wherein determining the electrical signatures is performed substantially continuously, the method further comprising providing one or more updates about one or more devices in the residence based on changes over time to one or more of the electrical signatures.
   I11. The method of clause I1, wherein determining at least one of the electrical signatures comprises transforming signal information from a time domain to a frequency domain.
   I12. The method of clause I1, wherein, for at least one of the electrical devices, the frequency of sampling is at least about twice the frequency of the electrical device signature.
   I13. The method of clause I1, wherein measuring the one or more characteristics of electrical power lines in the residence comprises measuring current in one or more of the electrical power lines.
   I14. The method of clause I1, wherein measuring the one or more characteristics of electrical power lines in the residence comprises measuring voltage in one or more of the electrical power lines.
   I15. The method of clause I1, further comprising providing one or more reports to a person associated with the residence, wherein the reports comprise real-time information about use of one or more of the electrical devices measured in the residence.
   I16. The method of clause I1, further comprising tracking an on/off state of one or more of the electrical devices.
   I17. The method of clause I1, further comprising reporting power consumption of one or more of the disaggregated devices at the residence.
   I18. The method of clause I1, wherein the notification relating to at least one of the events or conditions is of an actual adverse event or condition of one of the electrical devices in the residence.
   I19. The method of clause I1, wherein the notification relates to at least one of the events or conditions is of abnormal usage of at least one of the specific electrical devices.
   I20. The method of clause I1, wherein the notification relating to at least one of the events or conditions comprises notice of an increased likelihood of failure of at least one of the specific electrical devices.
   I21. The method of clause I1, wherein the notification relating to at least one of the events or conditions is of higher energy cost for at least one of the electrical devices.
   I22. The method of clause I1, wherein the notification relating to at least one of the events or conditions comprises a prediction of one or more adverse events.
   I23. The method of clause I1, wherein the notification relating to at least one of the events or conditions comprises a prediction of one or more adverse events, wherein the prediction is based on past usage information measured for the electrical device.
   I24. The method of clause I1, wherein the notification relating to at least one of the events or conditions is based at least on one or more historical patterns for at least one of the electrical devices.
   I25. The method of clause I1, wherein the notification relating to at least one of the events or conditions is based at least on one or more historical patterns relating to at least one of the electrical devices and on weather data.
   I26. The method of clause I1, wherein the notification relating to at least one of the events or conditions is based at least on one or more measurements of the electrical device and one or more conditions external to the device.
   I27. The method of clause I1, further comprising making one or more recommendations about one of the electrical devices based in part on measurements taken for the specific electrical device.
   I28. The method of clause I1, further comprising making one or more recommendations about one of the electrical devices based in part on measurements taken for the specific electrical device, wherein the one or more recommendations includes a repair option and a replace option.
   I29. The method of clause I1, further comprising making one or more purchase recommendations relating to at least one of the electrical devices, wherein the recommendation is based in part on measurements taken for the specific electrical device.
   I30. The method of clause I1, further comprising controlling one or more of the electrical devices based on at least one of the notifications.
   I31. The method of clause I1, further comprising controlling one or more of the electrical devices from a remote location based on at least one of the notifications.
   I32. The method of clause I1, further comprising displaying information about one or more electrical devices in the residence on a mobile device.
   I33. The method of clause I1, further comprising providing one or more notifications to a person associated with a residence, wherein the notification is based on smart meter data from the residence and analysis of one or more of specific electrical devices.
   J1. A method of managing electrical devices in a residence, comprising:
measuring one or more characteristics of electrical power lines in the residence;
determining, based at least in part on the measured electrical characteristics, electrical signatures for each of a plurality of electrical devices at the residence that are receiving electrical power from the electrical power lines;
detecting use by at least one specific one of the electrical devices, wherein the use by the specific electrical device is detected by using the electrical signature for the at least one specific electrical device;
providing, to a person associated with the residence, one or more device-specific notifications relating to at least one of the electrical devices in the residence; and
controlling, in response to at least one of the device-specific notifications, one or more of the electrical devices in the residence.
   J2. The method of clause J1, wherein controlling at least one of the electrical devices comprises sending an instruction to the at least one device over electrical power lines in the residence using power line communication.
   J3. The method of clause J1, wherein at least one of the notifications is by zone.
   J4. The method of clause J1, wherein controlling at least one of the electrical devices comprises receiving at least one instruction from the person to whom at least one of the notifications was provided.
   K1. A method of providing information about electrical devices in a residence, comprising:
measuring one or more characteristics of electrical power lines in the residence;
determining, based at least in part on the measured electrical characteristics, electrical signatures for at least two of a plurality of electrical devices at the residence that are receiving electrical power from the electrical power lines;
detecting use of at least one specific one of the electrical devices, wherein the use by the specific electrical device is detected by using the electrical signature for the at least one specific electrical device;
determining, based at least in part on the use detected by the at least one specific electrical device, a suggestion for acquiring one or more products or one or more services; and
providing the suggestion to a person associated with the residence.
   K2. The method of clause K1, wherein at least one of the suggestions is based on frequency of use of at least one of the devices.
   K3. The method of clause K1, wherein at least one of the suggestions is based on promoting enhanced enjoyment of at least one of the electrical devices in the residence.
   K4. The method of clause K1, wherein at least one of the suggestions is for acquisition of a product or service related to at least one of the electrical devices in the residence.
   K5. The method of clause K1, wherein at least one of the suggestions includes a promotion for at least one item.
   K6. The method of clause K1, wherein at least one of the suggestions is based on an actual failure of at least one of the electrical devices.
   K7. The method of clause K1, wherein at least one of the suggestions is based on a likelihood of failure of at least one of the electrical devices.
   K8. The method of clause K1, wherein at least one of the suggestions is based on degradation of at least one of the electrical devices.
   K9. The method of clause K1, wherein at least one of the suggestions is based on excess power usage by at least one of the electrical devices.
   L1. A method of managing levels of power consumption of electrical devices used by an organization in its facilities, comprising:
measuring one or more characteristics of electrical power lines in the set of one or more buildings in which the organization operates;
determining, based at least in part on the measured electrical characteristics, electrical signatures for at least two specific devices of a plurality of electrical devices at the one or more buildings that are receiving electrical power from the electrical power lines;
detecting power consumption of at least one specific one of the electrical devices, wherein the power consumption by the at least two specific electrical devices is detected by using the electrical signatures for the at least two specific electrical devices; and
determining, based at least in part on the power consumption detected by the at least two specific electrical devices, one or more operating specifications for the at least two electrical devices at the one or more buildings, wherein the one or more operational specifications manage a power consumption for electrical loads at the set of one or more buildings.
   L2. The method of clause L1, wherein the operating specifications are configured to reduce peak power consumption for electrical loads at the set of one or more buildings.
   M1. A system, comprising:
a plurality of conductors configured to couple with one or more sensors, wherein the sensors are configured to measure characteristics of power in electrical power lines;
an analog-to-digital converter configured to receive signals from the electrical power lines and convert the signals from analog signals to digital signals;
one or more processors configured to:
   receive, from the analog-to-digital converter, one or more digital signals;
   perform digital signal processing on at least one of the signals;
   determine, based on the digital signal processing, an electrical signature for at least one electrical device receiving power from at least one of the electrical power lines.
      M2. The system of clause M1, wherein the system is configured to couple with one or more electrical power lines at a breaker box of a residence.
      M3. The system of clause M1, wherein the electrical power lines supply power to electrical devices in a residence, wherein the system comprises a notification component configured to generate one or more notifications about events or conditions relating to electrical devices at the residence.
      M4. The system of clause M1, wherein the electrical power lines supply power to electrical devices in a residence, wherein the system further comprises a control component configured to generate a control signal to one or more electrical devices at the residence based on information about one or more specific devices in the residence acquired using at least one of the electrical signatures.
      M5. The system of clause M1, wherein the electrical power lines supply power to electrical devices in a residence, wherein the system further comprises a control component configured to generate a control signal to one or more electrical devices at the residence based on information about one or more specific devices in the residence.
      M6. The system of clause M1, wherein the electrical power lines supply power to electrical devices in a residence, wherein the system is configured to send one or more notifications by way of power line communications over electrical power lines in the residence.
      M7. The system of clause M1, wherein the electrical power lines supply power to electrical devices in a residence, wherein the system is configured to send one or more control signals by way of power line communications over electrical power lines in the residence.
      M8. A electrical signature capture pre-processing device, comprising:
a plurality of conductors configured to couple with one or more electrical sensors, wherein the sensors are configured to measure characteristics of power in in electrical power lines in a building;
an analog-to-digital converter configured to receive signals from the electrical power lines and convert the signals from analog signals to digital signals; and
an electrical signature pre-processing component, implemented on one or more processors, configured to:
   receive, from the analog-to-digital converter, one or more digital signals;
   perform digital signal processing on at least one of the signals to determine a set of information for computing an electrical signature for at least one specific electrical device in the building; and
   send information to an electrical signature computation component, wherein the information sent to the electrical signature computation component includes information for determining an electrical signature for at least one specific electrical device in the one or more buildings; and
a microcontroller configured to control one or more of the electrical devices in the building.
   M9. A system, comprising:
a plurality of conductors configured to couple with one or more sensors, wherein the sensors are configured to measure characteristics of power in electrical power lines;
one or more processors configured to:
   perform signal processing on at least one of signals; and
   determine, based on the signal processing, an electrical signature for at least one electrical device receiving power from at least one of the electrical power lines.
      M10. A method of providing information about electrical devices in a place, comprising:
measuring one or more characteristics of electrical power lines in a place;
determining, based at least in part on the measured electrical characteristics, electrical signatures for each of at least two of a plurality of electrical devices at the place that are receiving electrical power from the electrical power lines; and
detecting a state or usage level of at least one specific one of the electrical devices, wherein the state or usage level of by the specific electrical device is detected by using the electrical signature for the at least one specific electrical device.
   N1. A system for monitoring use of a liquid resource, comprising:
one or more sensors configured to measure flow of a liquid resource being used by an entity at a first place; and
a monitoring system coupled to at least one of the sensors, wherein the monitoring system is configured to automatically:
receive information about the flow rate of the liquid from at least one of the sensors;
acquire values associated with use of a liquid resource by the entity at the first place;
perform a normalization of at least one of the values; and
display, to at least one person of the entity, while the resource is being consumed at the first place by the entity, one or more comparisons based on at least one of the normalized values associated with consumption of the resource at the first place and one or more other values associated with consumption of the resource.
   N2. The system of clause N1, wherein the liquid resource comprises water.
   N3. The system of clause N1, wherein the liquid resource comprises oil.
   N4. The system of clause N1, wherein the monitoring system is further configured to:
measure consumption of electricity at the place by the entity; and
simultaneously report to a user both electrical usage information and liquid usage information.
   N5. A method of monitoring use of a liquid resource, comprising:
acquiring, by a computer system, values associated with use of a liquid resource by an entity at a first place;
performing, by the computer system, a normalization of at least one of the values; and
displaying, to at least one person of the entity, while the resource is being consumed at the first place by the entity, one or more comparisons based on at least one of the normalized values associated with consumption of the resource at the first place and one or more other values associated with consumption of the resource.
   N6. The method of clause N5, wherein the liquid resource is water, wherein the values associated with the use of the liquid resource comprises a flow rate of the water.
   N7. The method of clause N5, wherein the liquid resource is oil, wherein the values associated with the use of the liquid resource comprises a flow rate of the oil.
   N8. The method of clause N5, wherein at least one of the displayed comparisons comprises a real-time display of consumption by the first entity.
   N9. The method of clause N5, wherein the entity is an individual person, wherein at least one of the comparisons is displayed to the individual person while individual person is consuming the resource at the first place.
   N10. The method of clause N5, wherein the comparison comprises a comparison of consumption of the resource by the entity with consumption of the resource by at least one other entity.
   N11. The method of clause N5, wherein the comparison comprises a comparison of current consumption by the entity with consumption by the entity at a different time or under different conditions.
   N12. The method of clause N5, wherein acquiring values associated with consumption of the resource at the first place comprises measuring consumption of the resource at the first place.
   N13. The method of clause N5, wherein the first place is a building.
   N14. The method of clause N5, wherein the entity comprises occupants of the first place.
   N15. The method of clause N5, further comprising:
measuring consumption of electricity at the place by the entity; and
simultaneously reporting to a user both electrical usage information and liquid usage information.
   O1. A system for monitoring use of a gas resource, comprising:
one or more sensors configured to measure flow of gas being used by an entity at a first place; and
a monitoring system coupled to at least one of the sensors, wherein the monitoring system is configured to automatically:
receive information about the flow rate of the gas from at least one of the sensors;
acquire values associated with use of the gas by the entity at the first place;
perform a normalization of at least one of the values; and
display, to at least one person of the entity, while the gas resource is being consumed at the first place by the entity, one or more comparisons based on at least one of the normalized values associated with consumption of the resource at the first place and one or more other values associated with consumption of the resource.
   O2. The system of clause O1, wherein the monitoring system is further configured to:
measure consumption of electricity at the place by the entity; and
simultaneously report to a user both electrical usage information and gas usage information.
   O3. A method of monitoring use of a gas, comprising:
acquiring, by a computer system, values associated with use of a gas resource by an entity at a first place;
performing, by the computer system, a normalization of at least one of the values; and
displaying, to at least one person of the entity, while the resource is being consumed at the first place by the entity, one or more comparisons based on at least one of the normalized values associated with consumption of the resource at the first place and one or more other values associated with consumption of the resource.
   O4. The method of clause O3, wherein the values associated with the use of the gas resource comprises a flow rate of the gas.
   O5. The method of clause O3, wherein at least one of the displayed comparisons comprises a real-time display of consumption by the first entity.
   O6. The method of clause O3, wherein the entity is an individual person, wherein at least one of the comparisons is displayed to the individual person while individual person is consuming the resource at the first place.
   O7. The method of clause O3, wherein the comparison comprises a comparison of consumption of the resource by the entity with consumption of the resource by at least one other entity.
   O8. The method of clause O3, wherein the comparison comprises a comparison of current consumption by the entity with consumption by the entity at a different time or under different conditions.
   O9. The method of clause O3, wherein acquiring values associated with consumption of the resource at the first place comprises measuring consumption of the resource at the first place.
   O10. The method of clause O3, wherein the first place is a building.
   O11. The method of clause O3, wherein the entity comprises occupants of the first place.
   O12. The method of clause O3, further comprising:
measuring consumption of electricity at the place by the entity; and
simultaneously reporting to a user both electrical usage information and gas usage information.
   P1. A system for monitoring use of a liquid resource, comprising:
one or more sensors configured to measure flow of a liquid resource being used by an entity at a first place; and
a monitoring system coupled to at least one of the sensors, wherein the monitoring system is configured to automatically:
measure one or more flow characteristics of a liquid resource in the residence;
detect a state or usage level of the liquid resource of at least one specific device;
determine, based at least in part on the state or usage level detected by the at least one specific device, an event or condition associated with the at least one specific device; and
provide, to a person associated with the residence, one or more notifications relating to at least one of the events or conditions associated with the at least one specific device.
   P2. The system of clause P1, wherein the liquid resource comprises water.
   P3. The system of clause P1, wherein the liquid resource comprises oil.
   P4. The system of clause P1, wherein the monitoring system is further configured to:
measure consumption of electricity at the place by the entity; and
simultaneously report to a user both electrical usage information and liquid usage information.
   P5. A method of monitoring use of a liquid resource in a residence, comprising:
measuring one or more flow characteristics of a liquid resource in the residence;
detecting a state or usage level of the liquid resource of at least one specific device;
determining, based at least in part on the state or usage level detected by the at least one specific device, an event or condition associated with the at least one specific device; and
providing, to a person associated with the residence, one or more notifications relating to at least one of the events or conditions associated with the at least one specific device.
   P6. The method of clause P5, wherein the liquid resource is water.
   P7. The method of clause P5, wherein the liquid resource is oil.
   P8. The method of clause P5, wherein at least one of the events or conditions is determined based on the state of two or more of the devices.
   P9. The method of clause P5, wherein the notification is based on information about use of two or more devices monitored.
   P10. The method of clause P5, further comprising tracking an on/off state of one or more of the devices.
   P11. The method of clause P5, wherein the notification relating to at least one of the events or conditions is of an actual adverse event or condition of one of the devices in the residence.
   P12. The method of clause P5, wherein the notification relates to at least one of the events or conditions is of abnormal usage of at least one of the specific devices.
   P13. The method of clause P5, wherein the notification relating to at least one of the events or conditions comprises notice of an increased likelihood of failure of at least one of the specific devices.
   P14. The method of clause P5, wherein the notification relating to at least one of the events or conditions is of higher energy cost for at least one of the devices.
   P16. The method of clause P5, wherein the notification relating to at least one of the events or conditions comprises a prediction of one or more adverse events.
   P17. The method of clause P5, wherein the notification relating to at least one of the events or conditions comprises a prediction of one or more adverse events, wherein the prediction is based on past usage information measured for the device.
   P18. The method of clause P5, wherein the notification relating to at least one of the events or conditions is based at least on one or more historical patterns for at least one of the devices.
   P19. The method of clause P5, wherein the notification relating to at least one of the events or conditions is based at least on one or more measurements of the device and one or more conditions external to the device.
   P20. The method of clause P5, further comprising making one or more recommendations about one of the devices based in part on measurements taken for the specific device.
   P21. The method of clause P5, further comprising making one or more recommendations about one of the devices based in part on measurements taken for the specific device, wherein the one or more recommendations includes a repair option and a replace option.
   P22. The method of clause P5, further comprising making one or more purchase recommendations relating to at least one of the devices, wherein the recommendation is based in part on measurements taken for the specific device.
   P23. The method of clause P5, further comprising controlling one or more of the devices based on at least one of the notifications.
   P24. The method of clause P5, further comprising controlling one or more of the devices from a remote location based on at least one of the notifications.
   P25. The method of clause P5, further comprising displaying information about one or more devices in the residence on a mobile device.
   P26. The method of clause P5, further comprising:
measuring consumption of electricity at the place by the entity; and
simultaneously reporting to a user both electrical usage information and liquid resource usage information.
   Q1. A system for monitoring use of a gas resource, comprising:
one or more sensors configured to measure flow of a gas resource being used by an entity at a first place; and
a monitoring system coupled to at least one of the sensors, wherein the monitoring system is configured to automatically:
measure one or more flow characteristics of a gas resource in the residence;
detect a state or usage level of the gas resource of at least one specific device;
determine, based at least in part on the state or usage level detected by the at least one specific device, an event or condition associated with the at least one specific device; and
provide, to a person associated with the residence, one or more notifications relating to at least one of the events or conditions associated with the at least one specific device.
   Q2. The system of clause Q1, wherein the monitoring system is further configured to:
measure consumption of electricity at the place by the entity; and
simultaneously report to a user both electrical usage information and gas usage information.
   Q3. A method of monitoring use of a gas resource in a residence, comprising:
measuring one or more flow characteristics of gas in the residence;
detecting a state or usage level of the gas resource of at least one specific device;
determining, based at least in part on the state or usage level detected by the at least one specific device, an event or condition associated with the at least one specific device; and
providing, to a person associated with the residence, one or more notifications relating to at least one of the events or conditions associated with the at least one specific device.
   Q4. The method of clause Q3, wherein at least one of the events or conditions is determined based on the state of two or more of the devices.
   Q5. The method of clause Q3, wherein the notification is based on information about use of two or more devices monitored.
   Q6. The method of clause Q3, further comprising tracking an on/off state of one or more of the devices.
   Q7. The method of clause Q3, wherein the notification relating to at least one of the events or conditions is of an actual adverse event or condition of one of the devices in the residence.
   Q8. The method of clause Q3, wherein the notification relates to at least one of the events or conditions is of abnormal usage of at least one of the specific devices.
   Q9. The method of clause Q3, wherein the notification relating to at least one of the events or conditions comprises notice of an increased likelihood of failure of at least one of the specific devices.
   Q10. The method of clause Q3, wherein the notification relating to at least one of the events or conditions is of higher energy cost for at least one of the devices.
   Q11. The method of clause Q3, wherein the notification relating to at least one of the events or conditions comprises a prediction of one or more adverse events.
   Q12. The method of clause Q3, wherein the notification relating to at least one of the events or conditions comprises a prediction of one or more adverse events, wherein the prediction is based on past usage information measured for the device.
   Q13. The method of clause Q3, wherein the notification relating to at least one of the events or conditions is based at least on one or more historical patterns for at least one of the devices.
   Q14. The method of clause Q3, wherein the notification relating to at least one of the events or conditions is based at least on one or more measurements of the device and one or more conditions external to the device.
   Q15. The method of clause Q3, further comprising making one or more recommendations about one of the devices based in part on measurements taken for the specific device.
   Q16. The method of clause Q3, further comprising making one or more recommendations about one of the devices based in part on measurements taken for the specific device, wherein the one or more recommendations includes a repair option and a replace option.
   Q17. The method of clause Q3, further comprising making one or more purchase recommendations relating to at least one of the devices, wherein the recommendation is based in part on measurements taken for the specific device.
   Q18. The method of clause Q3, further comprising controlling one or more of the devices based on at least one of the notifications.
   Q19. The method of clause Q3, further comprising controlling one or more of the devices from a remote location based on at least one of the notifications.
   Q20. The method of clause Q3, further comprising displaying information about one or more devices in the residence on a mobile device Q21. The method of clause Q3, further comprising:
measuring consumption of electricity at the place by the entity; and
simultaneously reporting to a user both electrical usage information and gas usage information.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art after having the benefit of this description of the invention. Methods may be implemented manually, in software, in hardware, or a combination thereof. The order of any method may be changed, and various elements may be added, reordered, combined, omitted, modified, etc. Changes may be made in the elements described herein without departing from the spirit and scope of the invention as described in the following claims.

What is claimed is:

1. A method of managing power consumption of electrical devices, comprising:
identifying a plurality of electrical devices associated with an entity;
measuring one or more characteristics of electrical power lines providing electrical power to the electrical devices;
transmitting a signal for detecting use by the plurality of electrical devices;
transmitting a signal for predicting contributions of the plurality of electrical devices to peak power consumption for a utility provider providing electrical power to the entity;
transmitting a signal for providing, to a person associated with the entity, one or more device-specific notifications relating to at least one electrical device of the plurality of electrical devices of the entity, wherein the one or more device-specific notifications are based, at least in part, on the predicted contributions of the plurality of electrical devices to peak power consumption for the utility provider; and
transmitting a signal for controlling, in response to at least one of the device-specific notifications, the at least one electrical device, wherein the transmitted signal includes at least one control measure for the at least one electrical device that offsets peak power consumption for the utility provider.

2. The method of claim 1, further comprising transmitting a signal for receiving one or more user inputs associated with controlling at least one of the electrical devices, wherein the predicting contributions of the plurality of electrical devices to peak power consumption for the utility provider is based on, at least in part, the one or more user inputs.

3. The method of claim 1, further comprising transmitting a signal for receiving historical or predicted external weather information for the utility provider, wherein the predicting contributions of the plurality of electrical devices to peak power consumption for the utility provider is based on, at least in part, the external weather information.

4. The method of claim 1, wherein the predicting contributions of the plurality of electrical devices to peak power consumption for a utility provider is based on, at least in part, an energy usage capacity of at least one of the electrical devices.

5. The method of claim 1, further comprising transmitting a signal for making one or more recommendations about one or more of the plurality of electrical devices based in part on measurements taken for the at least one electrical device.

6. The method of claim 1, wherein the at least one control measure for the at least one electrical device that offsets peak power consumption for the utility provider includes precooling or preheating of a portion of a residence or building before peak power consumption for the utility provider.

7. The method of claim 1, further comprising:
transmitting a signal for determining, based at least in part on a state or usage level detected by the at least one electrical device, an event or condition associated with the at least one electrical device; and
transmitting a signal for providing, to a person associated with the entity, one or more notifications relating to at least one of the events or conditions associated with the at least one electrical device.

8. The method of claim 1, further comprising transmitting a signal for providing, to at least one person associated with the entity, power consumption information in comparison with at least one other entity.

9. The method of claim 1, further comprising:
transmitting a signal for determining, based at least in part on the measured characteristics of the electrical power lines associated with the entity, electrical signatures for each of the plurality of electrical devices that are receiving electrical power from the electrical power lines;
transmitting a signal for detecting use by at least one of the plurality of electrical devices, wherein the use by the at least one electrical device is detected based on the electrical signature for the at least one electrical device;
transmitting a signal for providing, to the person associated with the entity, one or more device-specific notifications relating to the at least one electrical device; and
transmitting a signal for controlling, in response to at least one of the one or more device-specific notifications, the at least one electrical device.

10. The method of claim 1, wherein the transmitting the signal for controlling the at least one electrical device comprises sending an instruction to the at least one electrical device over electrical power lines using power line communication.

11. The method of claim 1, wherein the identifying the plurality of electrical devices associated with the entity includes:
capturing, using one or more sensors coupled to the electrical power lines associated with the entity, power signals being transmitted between a power source and the plurality of electrical devices;
transforming the captured power signals from a time domain to a frequency domain;
determining electrical signatures in the frequency domain for each of the plurality of electrical devices based on the transformed signals; and
distinguishing between two or more of the plurality of electrical devices based on frequency characteristics in the frequency domain of the electrical signatures.

12. A system, comprising:
a resource consumption management system associated with a resource, comprising:
a processor;
a memory coupled to the processor and storing program instructions executable by the processor to implement:
identifying a plurality of electrical devices associated with an entity;
measuring one or more characteristics of electrical power lines providing electrical power to the electrical devices;
transmitting a signal for detecting use by the plurality of electrical devices;
transmitting a signal for predicting contributions of the plurality of electrical devices to peak power consumption for a utility provider providing electrical power to the entity;
transmitting a signal for providing, to a person associated with the entity, one or more device-specific notifications relating to at least one electrical device of the plurality of electrical devices of the entity, wherein the one or more device-specific notifications are based, at least in part, on the predicted contributions of the plurality of electrical devices to peak power consumption for the utility provider; and
transmitting a signal for controlling, in response to at least one of the device-specific notifications, the at least one electrical device, wherein the transmitted signal includes at least one control measure for the at least one electrical device that offsets peak power consumption for the utility provider.

13. The system of claim 12, wherein at least one of the notifications comprises information about the peak power consumption of one or more of the plurality of electrical devices associated with the entity.

14. The system of claim 12, wherein the transmitting the signal for controlling the at least one electrical device comprises receiving at least one instruction from the person to whom at least one of the notifications was provided.

15. The system of claim 12, wherein the resource comprises an electricity resource.

16. The system of claim 12, wherein the memory stores program instructions executable by the processor to implement:
transmitting a signal for determining, based at least in part on the measured characteristics of the electrical power lines associated with the entity, electrical signatures for at least two electrical devices of the plurality of electrical devices that are receiving electrical power from the electrical power lines;
transmitting a signal for detecting power consumption of the at least two electrical devices, wherein the power consumption by the at least two electrical devices is detected based on the electrical signatures for the at least two electrical devices; and
transmitting a signal for determining, based at least in part on the power consumption detected of the at least two electrical devices, one or more operating specifications for the at least two electrical devices, wherein the one or more operational specifications manage a power consumption for electrical loads by the entity.

17. The system of claim 12, wherein the at least one control measure is capable of controlling a setting on an air conditioning system providing cooling at a location of the entity.

18. The system of claim 12, wherein the at least one control measure comprises reducing lighting usage by the at least one electrical device.

19. The system of claim 12, wherein the at least one control measure comprises reducing plug loads by the at least one electrical device.

20. The system of claim 12, wherein the memory stores program instructions executable by the processor to implement transmitting a signal for determining, based at least in part on the one or more device-specific notifications, one or more goals for more efficient consumption of the resource by the plurality of electrical devices.
